(19) United States
(12) Patent Application Publication
(10) Pub. No.: US 2009/0083812 A1
(43) Pub. Date: Mar. 26, 2009

(54) Method and apparatus for controlling on-demand play of media files based on P2P protocols

(75) Inventor: Ke Tang, Beijing (CN)

Correspondence Address: BUCHANAN, INGERSOLL & ROONEY PC, POST OFFICE BOX 1404, ALEXANDRIA, VA, 22313-1404, US

(73) Assignee: BEIJING FUNSHION ONLINE TECHNOLOGIES LTD., Beijing (CN)

(21) Appl. No.: 12/010,081

(22) Filed: Jan. 18, 2008

(30) Foreign Application Priority Data
Jan. 19, 2007 (CN) 200710062866.5

(51) Int. Cl. H04N 7/173

(52) U.S. Cl. 725/93

(57) ABSTRACT

The present invention is to provide a method and apparatus for control on-demand play of media files based on P2P protocols, and its core idea lies in that, the download of the control information piece where the file control information is located is assigned with the highest priority when the on-demand play of streaming media files is implemented; while the download of the control information piece where the file control information is located and the index information piece where the index information is located are assigned with the highest priority, when the on-demand play of non-streaming media files is implemented, thereby playing while downloading of media files based on the P2P protocols.

### FIELD OF THE INVENTION

The present invention relates to Internet, and more particularly, to a control of on-demand play of media files based on P2P protocols.

### BACKGROUND OF THE INVENTION

P2P (Peer-to-Peer) is also called P2P networking, which means that roles, behaviors, responsibilities and obligations of all nodes in one network are equal. In this text, both a user apparatus (for example, personal computer) appearing in the P2P network as one peer and the user using the user apparatus, without any differentiation, are called by a general name of nodes.

Before the P2P technique is introduced, the Internet is in a mode called Client/Server (C/S for brevity), for example, WWW, online games, and the like, and the feature of the mode is that one central server is necessary to process most of computing works. But, this mode has a fatal disadvantage, that is, network resources required by the central server will be increased along with the increasing number of clients to be served. Obviously, this will constrain the increase of the number of clients eventually.

The P2P technique allows nodes to bypass a middleman to connect to other nodes for information interactions such as file transmissions and the like, so as to make the Internet “non-centralized” again, thereby coming a step closer to people's original intentions for developing the Internet technique.

Now, P2P application software, such as BT (based on BitTorrent protocols), eMule and the like which adopt an MFTP multi-source download technique, has became a part of netizen's life due to its features of fast transmission speed, high bandwidth usage, and so on. Each node is both a client and a server, and it downloads while uploading to other nodes. As a result, the larger the number of users is, the faster the download speed will be, and this is beyond imagination in the times of highly centralized Internet.

6 The core of the MFTP multi-source download technique comprises:

1. a resources file is divided into piecepieces with equivalent length so as to be marked and processed (although the length is equivalent, the size of equivalent piece can be adjusted);

2. it must be necessary for the node to learn the pieces that the other node has, such that they can supply what the other node needs, thereby achieving the aim of downloading while uploading;

3. after receiving one piece, the node needs to check whether the piece is correct, since even an error of one piece among thousands of pieces will result in damage of the whole resources file, for example, make media files unable to be played normally, lead to failures of running executable files, etc. In the BT software, a node acquires a whole description for files and checksum for each piece therein through a file named “Torrent”; and in the eMule, a node acquires, from other nodes, checksum for a piece while downloading the piece.

The precondition for playing media files is that a player loads a file control header (hereinafter, called file control information). Although able to implement high-speed file downloads, the BT, eMule and the like can not support playing while downloading due to out-of-order downloads of all pieces (including control information piece(s) where the file control information is located) of the file, and therefore, the node can play the media file only after the file is downloaded completely.

Therefore, it is obvious that, there is no control for on-demand play of media files based on the P2P technique and supporting playing while downloading in the prior art.

### SUMMARY OF THE INVENTION

To solve the above problem existing in the prior art and implement on-demand play of media files based on the P2P technique, the present invention is proposed.

According to a first aspect of the present invention, there is provided a method for controlling on-demand play of streaming media file in a user apparatus based on P2P protocols, comprising the following steps of: determining all control information pieces including file control information in plurality of pieces of said media file; and, based on the determined all control information pieces, acquiring, said file control information.

According to a second aspect of the present invention, there is provided a method for controlling on-demand play of non-streaming media file in a user apparatus based on P2P protocols, comprising the following steps of: determining all control information pieces including file control information in plurality of pieces of said media file; obtaining said file control information based on all determined control information pieces; and acquiring index information of the media file.

According to a third aspect of the present invention, there is provided a first on-demand play control means for controlling on-demand play of streaming media file in a user apparatus based on P2P protocols, comprising: a first determining apparatus for determining all control information pieces including file control information in plurality of pieces of said media file; and a first obtaining apparatus for obtaining said file control information based on all said determined control information pieces.

According to a fourth aspect of the present invention, there is provided a second on-demand play control means for controlling on-demand play of non-streaminging media file in a user apparatus based on P2P protocols, comprising: a first determining apparatus for determining all control information pieces including file control information in plurality of pieces of said media file; a first obtaining apparatus for obtaining said file control information based on all said determined control information pieces; and a second obtaining apparatus for obtaining index information of the media file.

By using the technical solution provided in the present invention, the play and download of media files are implemented at the same time based on the P2P protocols through giving high priority to the acquisition of file control information and also the acquisition of index information of non-streaminging media files. Preferably, good user experiences can be provided through assigning high priority to the data pieces close to the play location in plurality of pieces of the media file.

### BRIEF DESCRIPTION ON THE DRAWINGS

The other objects, features and advantages of the present invention will become more apparent from the description of non-limited embodiments, taken in conjunction with the appended drawings.

FIG. 1 is a schematic diagram illustrating a P2P network according to embodiments of the present invention;

FIG. 2 is a schematic diagram illustrating the format of common media files;

FIGS. 3a and 3b illustrate two alternative formats of the data portion of media files;

FIG. 4 is a flow chart illustrating a method for controlling on-demand play of streaminging media files based on the P2P protocols in a user apparatus according to a first embodiment of the present invention;

FIG. 5 is a flow chart illustrating a method for controlling on-demand play of streaminging media files based on the P2P protocols in a user apparatus according to a second embodiment of the present invention;

FIG. 6 is a flow chart illustrating a method for controlling on-demand play of non-streaminging media files based on the P2P protocols in a user apparatus according to a third embodiment of the present invention;

FIG. 7 illustrates download situation of the data portion of media files, corresponding to a variation of the third embodiment of the present invention;

FIG. 8 is a flow chart illustrating a method for controlling on-demand play of non-streaminging media files based on the P2P protocols in a node according to a fifth embodiment of the present invention;

FIG. 9 is a flow chart illustrating a method for controlling on-demand play of non-streaminging media files based on the P2P protocols in a node according to a sixth embodiment of the present invention;

FIG. 10 is a flow chart illustrating a method for controlling on-demand play of non-streaminging media files based on the P2P protocols in a node according to a seventh embodiment of the present invention;

FIG. 11 is a block diagram illustrating a first on-demand play control means for controlling on-demand play of streaminging media files based on the P2P protocols in a user apparatus according to embodiments of the present invention;

FIG. 12 is a block diagram illustrating a second on-demand play control means for controlling on-demand play of non-streaminging media files based on the P2P protocols in a user apparatus according to embodiments of the present invention; and

FIG. 13 is a schematic diagram illustrating a P2P software structure specifically implementing the on-demand play control solution proposed by the present invention.

### DESCRIPTION OF THE PREFERRED EMBODIMENTS

For easy understanding, some concepts appearing in the text are illustrated firstly:
piece: in the text, control information pieces including file control information, data pieces including data information and index information pieces including index information are all called pieces; in a same media file, the size of each piece is the same, and the size of pieces in common media files is about 64 KB-8 MB, typically 512 KB-1 MB;
control information piece: a piece including file control information;
data piece: a piece including data information of the data portion of media files;
index information piece: a piece including index information;
   it should be appreciated that one piece can play plurality of roles, when it includes at least two of the above three types of information, in the case that it can not be filled up with only one of the file control information, data information or index information. For instance, a piece at a juncture between the file control information and the data portion may include file control information (a portion or the whole) and data information (a portion), and therefore, it may function as control information piece and data piece respectively during the acquisition of file control information; the rest may be deduced by analogy;
download source: referring to a node owning some piece and offering it so as to be downloaded by other nodes.

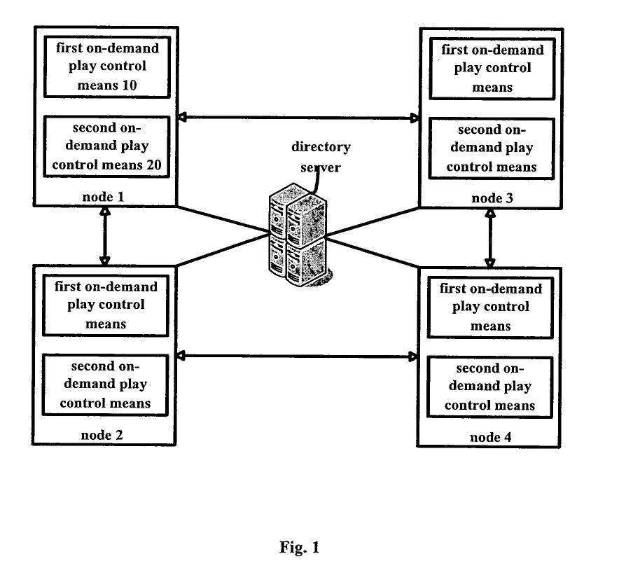

The P2P network shown in FIG. 1 according to embodiments of the present invention includes a plurality of nodes and one directory server, and only nodes 1, 2, 3, and 4 are shown for brevity. After logging in to the directory server, each node has to report resources information that it possesses to the directory server for the interaction withexchange other nodes. The directory server is called a Tracker in the BT, while in the eMule called an eMule server, and both for storing a list of peers owning a media file that a download task desires to download. The first and second on-demand play control means provided by the present invention are introduced into each node in the figure.

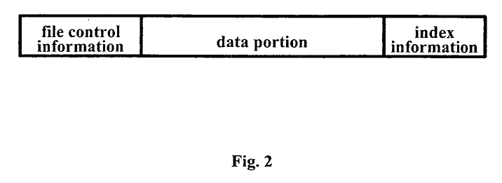

FIG. 2 is a schematic diagram illustrating the format of common media files, which applies, but not limited, to AVI, RMVB, RM, WMV, ASF, and the like. Among them, RMVB, RM, WMV, ASF files belong to streaminging media files, and AVI files belong to non-streaminging media files. The structure shown in the figure includes file control information, data portion and index information, in which:

file control information: including global control information such as index information location, media format, decompression decoder identification, data portion location, data portion format, play time period of the media file, etc.;

data portion: a portion decisive of media file size, for describing picture information of video files;

index information: including description of frame location (especially intra frames) in the data portion, particularly, including the following information: frame time stamp, frame number, beginning and ending locations of frame in a media file. The index information is necessary for the play of non-streaminging media files, but not necessary for the play of streaminging media files.

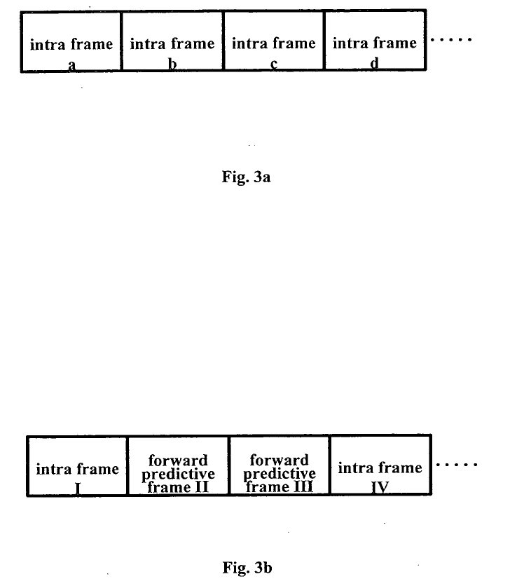

FIGS. 3a and 3b illustrate two of plurality of alternative formats of the data portion in media files. Wherein, an intra frame describes complete picture information of a basic picture, and a predictive frame describes the difference between a picture to which the predictive frame corresponds and a reference picture (for example, the basic picture described by the intra frame).

In the format shown in FIG. 3a, the data portion only includes intra frames and is applicable for the situation that is not sensitive to compression ratio since media files with this format usually have a pretty large size.

Based hereupon, a concept of predictive frame is introduced to improve the compression ratio of media files. As shown in the FIG. 3b, the data portion of a media file includes intra frames and their forward predictive frames (if existing). The play (display) order of each frame is consistent with the sequence according to which the each frame is stored in a media file, and also consistent with the decoding sequence in a decoder. Both predictive frames II and III make reference to an intra frame I. To implement the play order as shown in FIG. 3b, one typical operation of a decoder is as follows:

decoding the intra frame I and putting it into a buffer;

decoding, in combination with the intra frame I, the predictive frame II and putting it into a buffer;

decoding, in combination with the intra frame I, the predictive frame III and putting it into a buffer;

decoding the intra frame IV and putting it into a buffer, and so on;

the play apparatus gets, from the buffer, the each decoded frame for playing.

The type of each frame can be determined according to frame type indication information in a frame head.

It should be understood by those skilled in the art that the present invention is that, according to the video download solution based on P2P protocols, the frame to be played can be found using file control information (further including index information in the case of non-streaminging media files) through assigning priority to the acquisition of file control information (also the acquisition of index information in the case of non-streaminging media files), thereby playing while downloading. The course of decoding each frame which has been found and downloaded can be implemented according to various existing decoding schemes, depending on the specific media file format. In real practice, it is only needed to divide the frames and put them into a decoder one by one.

A description of the first aspect of the present invention will be given hereinafter in conjunction with flowcharts.

It should be understood that, sequence relationships between steps shown in the flowcharts related to this text are only specific to embodiments, but not for limiting the protection scope of the present invention, as partial operations in the present invention are implemented on each piece or each frame separately.

To satisfy user experiences with different optimization degrees, the first aspect of the present invention has following embodiments:

### A First Embodiment

### A Method for Controlling on-Demand Play of Streaming Media Files According to the First Aspect of the Present Invention, in which Data Pieces are Downloaded Using Existing Techniques, and Neither a Frame Skip Pattern Nor a Drag and Drop Function is Supported

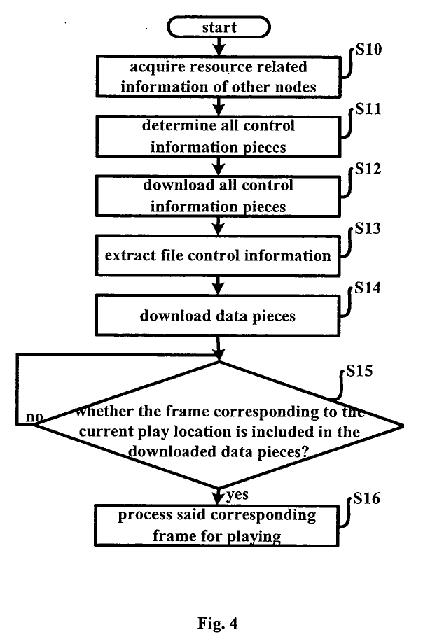

FIG. 4 is a flow chart illustrating a method for controlling on-demand play of streaming media files based on the P2P protocols in a node according to the first embodiment of the present invention, and a description will be given with reference to the FIG. 4 and in conjunction with FIGS. 1, 3a and 3b. It is assumed that the node needing on-demand play of streaming media files is node 1 shown in FIG. 1.

In S10, node 1 acquires resource related information of nodes 2, 3 and 4, and thus learns pieces that each other node has, so as to select download sources appropriately when downloading corresponding pieces. Because nodes 2, 3 and 4 are possibly downloading pieces belonging to the media file while acting as download sources for node 1, in S10, node 1 not only acquires related information of nodes 2, 3, 4 resources from the directory server, but also, through resource information report messages from nodes 2, 3, 4 having established connection with node 1, acquires resources related information of these nodes. There have been mature solutions supporting this, for example, after downloading one piece successfully, a node adopting the BT software sends “Have” messages including the piece's identification to each other node connected therewith, to show that it has the piece.

In S11, node 1 determines all control information pieces among plurality of pieces of the media file. The feasibility of this step depends on that, there are some constrains for piece size and the size of file control information of media files, and moreover, the file control information is always located at a specific place (for instance, header) of media file. It is easy to understand that, if the file type of the media file has been determined according to description information of the media file (for example, the description information carried by a Torrent file) ahead, the range of the size of the file control information will be more easily to be estimated. Taking a RMVB file as an example, its file control information is generally within 50 KB. Alternatively, the node 1 may determine several pieces (the precondition that all control information can be included therein can then be satisfied), and generally, 1-2 pieces are roughly enough to accommodate the whole file control information.

In S12, node 1 downloads all determined control information pieces to the local area, wherein download source of each piece can be determined based on the resource related information of each other node acquired before.

In S13, node 1 extracts file control information of the media file from said all control information pieces, and the preparation for playing the streaming media file is basically completed after the player (playing module) loads the file control information.

There is no strict sequence relationship between step S14 and steps S10-S13, that is to say, the download of data pieces can be implemented simultaneously with the acquisition of the file control information or thereafter. In this embodiment, the download of data pieces is still implemented using solutions such as out-of-order download, assigning priority to rare pieces, and the like used in the existing techniques as BT or eMule.

Therefore, when a user clicks for example a link to “Schindler's List”, node 1 will acquire the file control information according to the above steps, after the player loads the file control information, the default current play location is the beginning of the data portion of the media file, for example, 00 hour: 00 minute: 00 second: 000 millisecond. This is also consistent with people's habits of enjoying media files.

To display a picture corresponding to the current play location successfully, the player needs to decode the frame corresponding to the location. So, in S15, node 1 judges whether the frame corresponding to said current play location is included in the data pieces which have been downloaded. It is assumed that the intra frame a in FIG. 3a is at the beginning of the data portion, and thus, the frame corresponding to the location 00 hour: 00 minute: 00 second: 000 millisecond is this intra frame a. After the play of the intra frame a is finished, the frame corresponding to a next current play location of 00 hour: 00 minute: 00 second: 040 millisecond is the intra frame b. It is assumed that a intra frame I in FIG. 3b is at the beginning of the data portion, then the frame corresponding to 00 hour: 00 minute: 00 second: 000 millisecond is this intra frame I. When the play of the intra frame I is finished, the frame corresponding to the next current play location of 00 hour: 00 minute: 00 second: 040 millisecond is the combination of the intra frame I and a forward predictive frame II (since decoding and displaying of a predictive frame relies on an intra frame).

Please refer to FIG. 3a. In S15, node 1 judges whether intra frame a is completely included in the downloaded data pieces.

Node 1 judges in S15 whether intra frame a is completely included in the downloaded data pieces. Said judgment can be implemented based on the following facts:

1. the location (for example, i-th byte) corresponding to a time point in the data portion can be calculated according to the time point corresponding to the current play location and bit rate of the media file;

2. it is possible to locate said corresponding frame in data pieces exactly (for example, from j-th byte to k-th byte of N-th piece), as the piece size and frame length are known, and moreover the pieces have their respective labels.

Generally, the judgment can be implemented through determining whether the player can read the intra frame a successively Consequently, a judging result can be acquired.

If the judging result shows that intra frame a is completely included in downloaded data pieces (the player reads intra frame a successfully), a decoding operation and other associated processes are implemented with respect to intra frame a in S16 for playing.

When the play of intra frame a is finished, the new current play location is changed correspondingly (for example, to 00 hour: 00 minute: 00 second: 040 millisecond, pointing to the frame header of the intra frame b), and then, S15 and the follow-up steps are implemented with respect to said new current play location, wherein it is supported by the existing technology that the play location is changed automatically after one frame is played successfully.

If the judging result shows that, the intra frame a is not completely included in the download data pieces, node 1 will keep the current play location unchanged, that is, S15 will be performed continuously till the download of intra frame a is finished completely, and then the processes such as decoding, etc. are implemented in S16 so as for playing. During said waiting process, users can be prompted that the current on-demand play is in a “loading” state.

Now refer to FIG. 3b. In the compression manner where predictive frames are introduced, the frame corresponding to the location 00 hour: 00 minute: 00 second: 000 millisecond is the intra frame I. When the download of the intra frame I has not been finished completely, the player cannot read it successfully, and thus, a negative judging result will be acquired from S15. Accordingly, S15 is repeated till the download of the intra frame I is finished completely, and then the operations such as decoding, etc. in S16 are implemented thereon for playing.

Still refer to FIG. 3b. After the play of the intra frame I, a new play location corresponds to a frame group consisted of the intra frame I and the forward predictive frame II, and correspondingly, node 1 implements the judgment in S15 with respect to said new play location. If the download of the forward predictive frame II has not been finished at this moment, the method may implement said judgment in S15 with respect to this new play location continuously till the download of the forward predictive frame II is finished.

As index information is not necessary for playing non-streaming media files, index information pieces can be downloaded together with data pieces out-of-order in this embodiment, or not downloaded.

It is obvious that, in the first embodiment, users have bad experiences due to a long waiting period, because priorities of data pieces have no difference, exactly speaking, download priorities of data pieces are not associated with the current play location. The second embodiment optimizes the download priorities of data pieces on this basis, and the detailed description is as follows:

### A Second Embodiment

### A Method for Controlling on-Demand Play of Streaming Media Files According to the First Aspect of the Present Invention, in which Download Priorities of Data Pieces Are Determined According To The Current Play Location, And Neither a frame skip pattern Nor a Drag and Drop Function is Supported

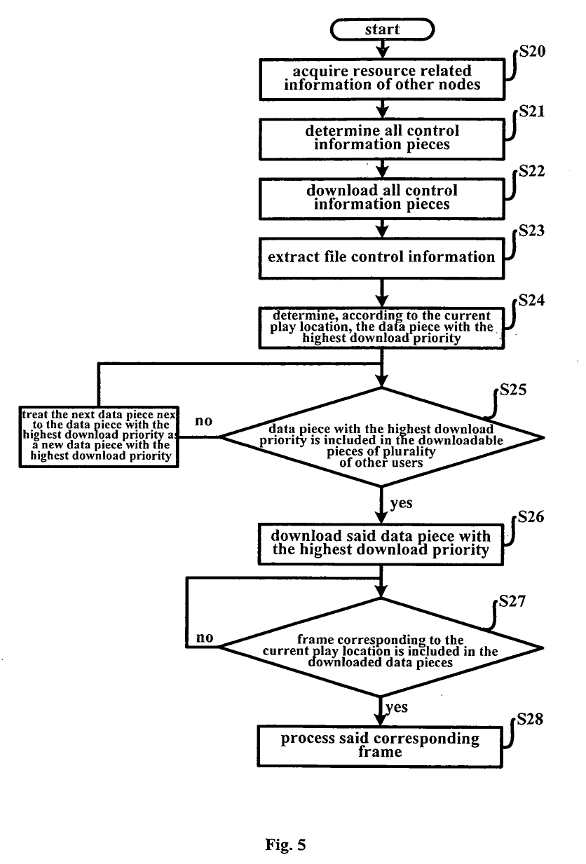

FIG. 5 is a flow chart illustrating a method for controlling on-demand play of streaming media files based on the P2P protocols in a node according to the second embodiment of the present invention, and a description will be given with reference to FIG. 5 and in conjunction with FIGS. 1, 3a and 3b.

The steps which are the same as those shown in FIG. 4 are still shown in the FIG. 5 for giving a complete solution. But, their corresponding textual descriptions are relative simple, and related description parts of FIG. 4 can be referred to for the details.

According to the basic idea of the present invention, the acquisition of the file control information of the media file, which is implemented according to resource related information of other nodes, is given the highest priority. Furthermore, the current play location is taken into consideration, to give priorities to data pieces appropriately. Preferably, the download priorities of data pieces are set according to their distance from the current play location in the direction of play of the media file. The shorter the distance is, the higher the download priority of the data piece will be; while the longer the distance is, the lower the download priority of the data piece will be. Additionally, in response to the change of the current play location due to some reasons (such as frame skip, drag and drop, and the like mentioned in the following text), download priorities of data pieces will change correspondingly. The shorter the distance from the new current play location is, the higher the download priority of the data piece will be; while the longer the distance is, the lower the download priority of the data piece will be. By doing so, the download of one data piece with the highest download priority will be the first one to be downloaded among un-downloaded data pieces.

Specifically, the current play location in the media file can be determined according to the bit rate of the media file and the time point, and thus, the data piece corresponding to the location can be determined, and is determined as the one with the highest download priority.

So, with respect to the initial current play location 00 hour: 00 minute: 00 second: 00 millisecond in the media file, the data piece which has been given the highest priority is located at the header of the data portion.

And then, the process proceeds to S25, wherein, node 1 judges, according to resource related information of other nodes mastered ever before, whether the data piece that has been assigned the highest download priority in S24 is included in downloadable pieces of other nodes. Specifically, said judgment is implemented according to the piece number of the data piece with the highest priority, and based on the information acquired from the directory server and resource information report messages (for instance, “Have” message) from other nodes.

If the judging result shows that said data piece with the highest priority is included in downloadable pieces of other nodes, node 1 determines one download source and downloads the data piece in S26. Said download source can be selected randomly. Preferably, node 1 chooses the node offering a highest download speed to it as the download source of the piece, among those nodes possessing the piece.

If the judging result shows that this data piece with the highest priority is not included in the downloadable pieces of other nodes, node 1 treats the next data piece near this data piece with the highest priority as a new data piece with the highest priority, and then goes back to S25 to implement corresponding judgment thereon.

Additionally, when the download speed may exceed the play speed, in other words, when the data piece with the highest priority falls into the data pieces which have already been downloaded, the method finds downwards from this data piece with highest priority along the direction of file play, till one data piece that has not been downloaded is found, and then it is determined as a new data piece with the highest priority. Then, it is determined whether there is any node can offer the download, if any, the new data piece with the highest priority is downloaded. The above situation may exist in the following cases:
network speed and resources situation are both ideal enough;
a user drags and drops in the direction opposite to the play direction based on other embodiments (fast rewind);
a user pauses or stops the play, and therefore, the downloader (downloading module) is allowed to go on working and the like.

This embodiment ensures the adaptability between a download object (data piece) and the current play location. As a result, user experiences are improved, because the buffering time needed by the play is shortened under the same network condition, and further, the procedure of playing the media file while downloading becomes smoother.

### A Third Embodiment

### A Method for Controlling on-Demand Play of Streaming Media Files According to the First Aspect of the Present Invention, in which Download Priorities of Data Pieces are Determined According to the Current Play Location, and a Frame Skip Pattern is Supported But the Drag and Drop Function is not Supported

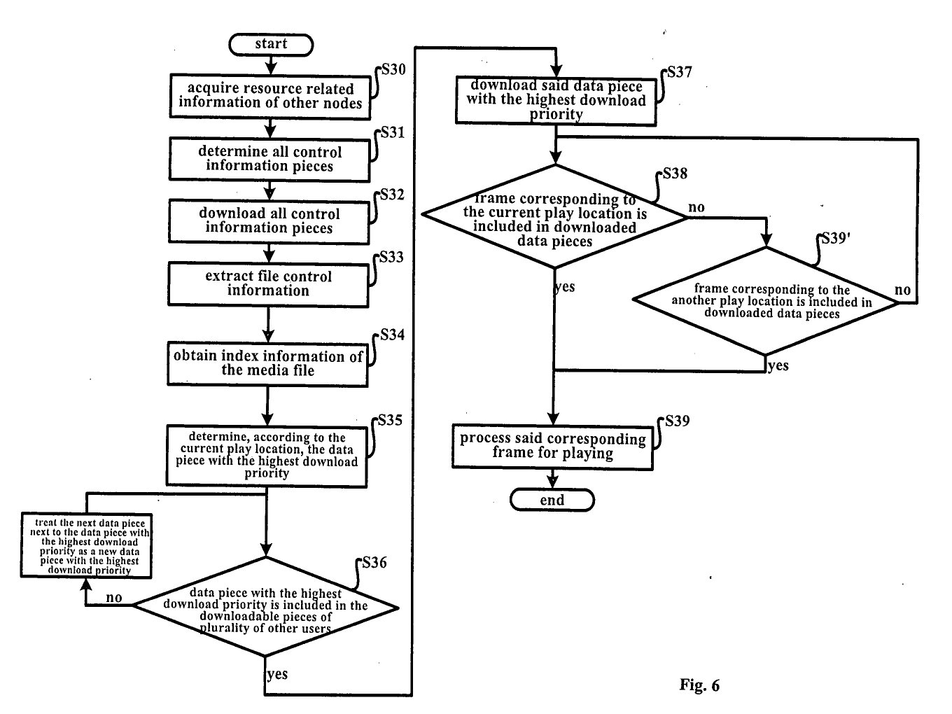

FIG. 6 is a flow chart illustrating a method for controlling on-demand play of streaming media files based on the P2P protocols in a node according to a third embodiment of the present invention, and a description will be given with reference to the FIG. 6 and in conjunction with FIGS. 1, 3a and 3b.

In this embodiment, the index information of a media file is needed in order to support the frame skip pattern, and there is no strict sequential relationship between S34 of acquiring the index information and steps S30-S33. Likewise, while implementing S30-S33 and S34, data pieces can be downloaded from other different users at the same time, as the P2P technique is a multi-source download technique.

The index information can be acquired in anyone of the following manners:

a. computing index information location according to the file control information so as to determine all index information pieces exactly, and then extracting the index information after downloading these index information pieces;

b. learning the file type of the media file according to the description information in a Torrent file, thereby computing the index information location roughly to determine all index information pieces and then extracting the index information after downloading.

The procedure of acquiring the index information is based on the following facts: there are some constrains for piece size and size of index information of medial file, and the index information is always at a specific location (for instance, tail) of the media file. The sizes of index information of different types of media files are dramatically different. As an example, index information of media files in AVI and WMV formats is usually around 1-5 MByte, while that of media files in RMVB format is relatively small, about 256-500 Kbyte. It is easy to understand that, determining the file type is helpful to estimate the size of index information more easily and thus determine all index information pieces.

A description about how to implement the frame skip pattern during on-demand play of a streaming media file according to the third embodiment is given as follows.

Please refer to FIG. 3a. It is assumed that, at the beginning of on-demand play of the file, the intra frame a in FIG. 3 is denoted by the play location “00 hour: 00 minute: 00 second: 00 millisecond”.

If it is judged in S38 that the download of the intra frame a has been completely finished (for instance, the decoder or player has read the intra frame a successfully), the process proceeds to S39 so that the decoding and the like processes are implemented on the frame corresponding to the location “00 hour: 00 minute: 00 second: 000 millisecond”, i.e., the intra frame a, for playing. When the play of the intra frame a is finished, the new current play location will point to the intra frame b, and then the judgment in S28 is implemented on the intra frame b.

Contrarily, if it is judged in S38 that the intra frame a is completely included in the downloaded pieces (for instance, only some of the data information of frame a or none of the data information thereof is included, making the decoder or player unable to read the intra frame a successfully), node 1 preferably judges in S39′, according to said index information, whether there is another play location that the download of its corresponding frame has been finished, among other play locations (corresponding to intra frame b, c, d, etc. respectively) after the current play location “00 hour: 00 minute: 00 second: 00 millisecond”. The index information generally includes location information of intra frame (for instance, corresponding time point of each intra frame in the play period of the media file, mapping information between said time point and corresponding file offset, number of piece where each intra frame is located and specific location thereof in that piece, or the like), and in some cases, further includes location information of various other frames (for example, forward predictive frame, bi-directionally predictive frame, etc.).

In a word, node 1 can locate, according to the index information, at least some intra frame in the media file. Additionally, the data information (for instance, from the i-th byte to the j-th byte of the N-th piece) corresponding to the each intra frame can be determined in the data piece according to the bit rate of media file and piece size. Accordingly, the judgment in S39′ is implemented.

If there is no such play location, alternatively, the method returns to the S38, to re-judge whether the download of the frame corresponding to the current play location “00 hour: 00 minute: 00 second: 00 millisecond”, i.e., the intra frame a, has been finished.

If there are one or more such play locations, alternatively, the method selects one play location from those locations as a new current play location, and the process proceeds to S39 so that the decoding and the like processes are implemented on the corresponding frame for playing. Preferably, the method selects, from the play locations satisfying this condition, the one closest to the current play location as the new current play location, and the decoding and the like processes are implemented thereon for playing.

Alternatively, in S39′, node 1 may implement the following operations based on the index information:

1) judging whether the frame (the intra frame b) corresponding to the next play location (for instance, 00 hour: 00 minute: 00 second: 040 millisecond) of the current play location is included in the downloaded data pieces;

1.1) if the judging result in 1) is yes, the location 00 hour: 00 minute: 00 second: 040 milliseconds will be treated as the new current play location, and then the decoding and the like processes are implemented on the corresponding frame, i.e., the intra frame b for playing.

1.2) if the judging result is no, it means that the download of several data pieces where the intra frame b is located has not been finished, and then, it is judged again whether a frame (frame c) corresponding a further next play location (for example, 00 hour: 00 minute: 00 second: 080 milliseconds) is included in the downloaded data pieces;

1.2.1) if the judging result in 1.2) is no, the above judgment is implemented on the frame (frame d) corresponding to the further next play location (00 hour: 00 minute: 00 second: 120 millisecond).

Once a positive determining result is acquired, the method will proceed to S39 so that the decoding and the like processes are implemented on the frame corresponding to the corresponding play location for playing.

The above has described, in accordance with this embodiment, the on-demand play control of media files whose storing sequence for data portion is as shown in FIG. 3a. Hereunder, the on-demand play control of media files with predictive frames will be illustrated with reference to FIG. 3b.

The current play location is set to 00 hour: 00 minute: 00 second: 000 millisecond, and its corresponding frame is the intra frame I. If the download of the intra frame I has been finished, decoding and the like processes are implemented thereon, and then it is put into a buffer or played;

and then, it is judged whether the download of the frame(s) corresponding to the next play location 00 hour: 00 minute: 00 second: 040 millisecond, i.e., “intra frame I and forward predictive frame II” has been finished.
if the download has been finished, the forward predictive frame II will be decoded (combined with the intra frame I) and displayed, and the intra frame I is still in the buffer; it is judged whether the download of the frame corresponding to the further next play location 00 hour: 00 minute: 00 second: 080 millisecond, “intra frame I and forward predictive frame III” has been finished, and the rest may be deduced by analogy;
if the download of “intra frame I and forward predictive frame II” has not been finished, it is further judged, according to the index information, whether the download of the next intra frame after the intra frame I in the downloaded data pieces has been finished. If the download of the next intra frame has been finished, the decoding process will be implemented thereon.

It should be understood that, the frame corresponding to the play location (including but not limited to the current play location or the next play location) mentioned in the text is an intra frame, or an intra frame and its one or more predictive frames. In the frame skip pattern, the destination play location of frame skip varies case by case due to the different description information in the index information, that is to say, if the index information has identified locations of all frames (regardless of intra frames or predictive frames) in the media file, the player will read the forward predictive frame II unsuccessfully when the download of the intra frame I is finished but the download of the forward predictive frame II is not, and therefore, the player can go to the play location corresponding to the forward predictive frame III, for example 00 hour: 00 minute: 00 second: 080 millisecond. Accordingly, it can be judged whether the download of the frame corresponding to the play location, i.e., “intra frame I and forward predictive frame III”, has been finished.

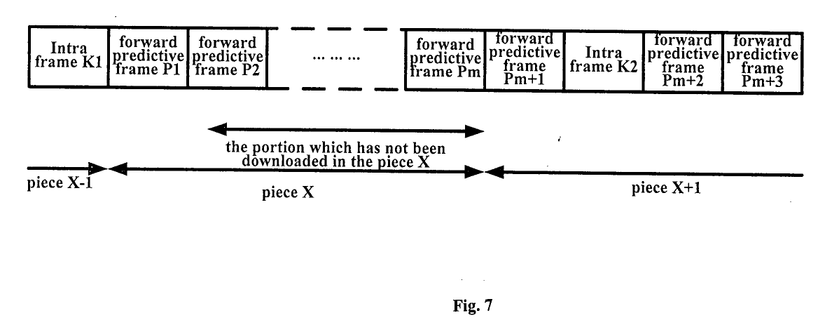

The third embodiment has a variation, the brief description of which is given as follows. Please refer to FIG. 7. FIG. 7 illustrates download situation of the data portion of the media file corresponding to said variation. A dashed line refers to the situation that the download has not been finished.

It is assumed that the player is playing a forward predictive frame P1 currently, and finds that the predictive frame P2 can not be read, which is possibly due to that P2 has wholly or partially fallen into the piece X's portion which has not been downloaded.

Then, the player calculates, according to the bit rate of the media file, one estimated value of the play period to which the piece X actually corresponds.

As compression algorithms adjust the bit rate dynamically according to real situation of media files, neither the time period corresponding to each data piece nor the number of frames included in each data piece is certain, and the description information of these frames may be included in the index information.

For example, it is assumed that the piece size of the media file is 256 Kbyte and the average bit rate is 512 kbps, then each data piece occupies 4 seconds approximately. The computing manner of the average bit rate is: average bit rate=overall size of the data portion/(division sign) play period of the media file given by the file control information.

It is assumed that P2 is at 5 minute 10 second, and therefore, the piece X which has not been downloaded is skipped over so as to go to 5 minute 14 second for example, and the index information is read to query the frame corresponding to 5 minute 14 second. After the offset location of the frame in the file is acquired, it is queried whether the file piece corresponding to the offset location is piece X. If so, the download of the frame must have not been finished, and then the next frame will be searched till one frame located completely in piece X+1 is found (say, both the offset location corresponding to the beginning time point and the offset location corresponding to the ending time point fall into the piece X+1), and the frame is Pm+1. Being acquired, Pm+1 is given to the decoder for decoding.

Another case is that, the frame corresponding to 5 minute 14 second is in Pm+3, and the former frames go to waste slightly. Preferably, several downloaded frames can be searched backwards (along the direction towards the header of the data portion) and then given to the decoder for decoding, thereby reducing the lost of downloaded frames.

### A Fourth Embodiment

### A Method for Controlling on-Demand Play of Streaming Media Files According to the First Aspect of the Present Invention, in which Download Priorities of Data Pieces are Determined According to the Current Play Location, and Both a Frame Skip Pattern and the Drag and Drop Function are Supported

When watching a media file, a user may need to choose one play location as a new current play location, and this is the so-called drag and drop function.

Specifically, the user can make the play process go to the new play time point, corresponding to the new play location, of the media file, through inputting user denoting information for denoting the chosen new play location, and then play backwards sequentially. The implementation of inputting user denoting information may include (but not limited to): a. the user may drag a seek bar on the player to the designated location (corresponding to the new play location); b. the user may input one play time point corresponding to the new play location in the media file directly.

Still refer to FIG. 6. In this embodiment, the method further includes the step (not shown) of “determining a new current play location according to the user denoting information”. Therefore, node 1 determines, according to the new current play location determined by the user denoting information, data pieces with high priority, and judges, in S38, whether the download of the frame corresponding to said new current play location has been finished.

After the user sends, using computer peripherals, the user denoting information to a first on-demand play control means, the determination of the new current play location can be implemented according to the following operations:

a. receiving the user denoting information; and

b. searching one play location corresponding to the time point according to the time point in the user denoting information and based on the index information, specifically, searching one intra frame corresponding to the time point.
if the time point just corresponds to one intra frame, the decoding and the like processes are implemented on the frame group where the intra frame is located, and then buffered or played.
if the time point does not correspond to an intra frame exactly, one intra frame closest to the time point is searched preferably, and more preferably, one intra frame closet to the time point and after the time point in terms of play sequence is searched.

Next, the determined frame group where the intra frame is located is processed, specifically, S38 and follow-up operations are implemented on the frame group, and the detailed description thereof can refer to each above embodiment.

The fourth embodiment has a variation, and the brief description of which is given as follows:
reading the index information, finding the frame closest to the time in the user denoting information, and acquiring the beginning and ending locations of the frame in the media file;
searching the data piece corresponding to said beginning and ending locations;
judging whether the download of the piece has been finished;
   if the download has not been finished, waiting until the download of the piece has been finished (or implementing frame skip automatically according to the third embodiment); and then, the data piece is treated as the one with highest priority;
   if the download has been finished, reading the frame and giving it to the decoder for decoding, and a first data piece of which the download has not been finished after the data piece is determined as the data piece with the highest priority.

Similar with the first aspect of the present invention, the second aspect of the present invention has several embodiments corresponding to user experiences with different optimization degrees, described in detail as follows.

### A Fifth Embodiment

### A Method for Controlling on-Demand Play of Non-Streaming Media Files According to a Second Aspect of the Present Invention, in which the Download of Data Pieces is Implemented Using Existing Techniques, and Neither the Frame Skip Pattern Nor the Drag and Drop Function is Supported

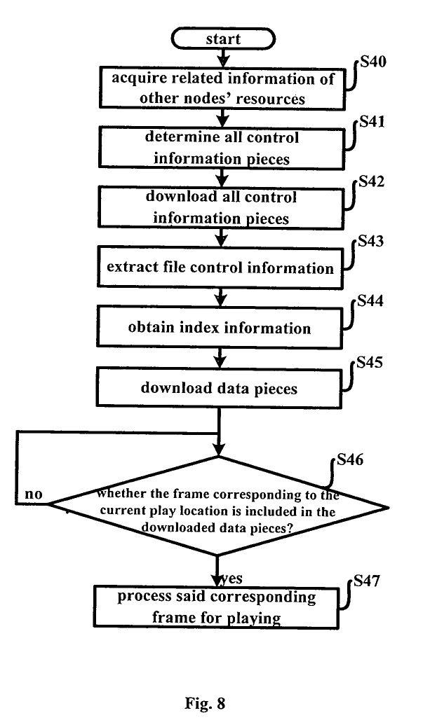

FIG. 8 is a flow chart illustrating a method for controlling on-demand play of non-streaming media files based on the P2P protocols in a node according to a fifth embodiment of the present invention, and a description will be given with reference to the FIG. 8 and in conjunction with FIGS. 1, 3a and 3b. It is assumed that the node needing on-demand play of non-streaming media files is node 1 shown in FIG. 1.

In S40, node 1 acquires resource information of nodes 2, 3 and 4, and thus learns what pieces each other node has, so as to select download sources appropriately when downloading corresponding pieces. Because nodes 2, 3 and 4 are possibly downloading pieces belonging to the media file while playing as download sources, in S40, node 1 not only acquires resource information of other nodes from the directory server, but also, through resources information report messages from nodes 2, 3 and 4 having established connection with node 1, acquires resource related information of these nodes. There have been mature solutions supporting this, for example, after downloading one piece successfully, a node adopting the BT software sends “Have” messages including the piece's identification to each other node connected therewith, to show that it has the piece.

In S41, node 1 determines all control information pieces among plurality of pieces of the media file. The feasibility of this step depends on that, there are some constrains for piece size and size of file control information of media files, and the file control information is always located at a specific place (for instance, header of the media file) of media files. It is easy to understand that, if its file type has been determined according to description information of the media file (for example, the description information carried by a Torrent file) ahead, the range of size of the file control information will be more easily to be estimated. Alternatively, the node may determine several pieces (the precondition that all control information can be included therein can then be satisfied), and generally, 1-2 pieces are roughly enough to accommodate the whole file control information.

In S42, node 1 downloads all determined control information pieces to the local area, wherein download source of each piece can be determined based on the resource related information of each other nodes acquired before.

In S43, node 1 extracts the file control information of the media file from said all control information pieces.

In S44, node 1 acquires the index information of the media file. The specific implementation can include the steps of downloading all index information pieces after determined, and extracting index information therefrom. The index information pieces can be determined exactly according to the index information location calculated based on the file control information after the file control information is acquired, or determined roughly according to the file type. In other words, the download of index pieces and the download of control information pieces can be carried out at the same time, without precedence order.

Likewise, the download of data pieces in S45 can be implemented in simultaneous with the download of control information pieces and index information pieces, or after the download of the control information pieces. In this embodiment, the download of data pieces is still implemented using solutions such as out-of-order download, assigning priority to rare pieces, and the like used in the existing techniques as BT or eMule.

Therefore, when a user clicks for example a link to “Schindler's List”, node 1 will acquire the file control information and index information according to the above steps, after the player loads the file control information and the index information, the default current play location is the beginning of data portion of the media file, for example, 00 hour: 00 minute: 00 second: 000 millisecond. This is also consistent with people's habits of enjoying media files.

To successfully display a picture corresponding to the current play location, the player needs to decode the frame corresponding to the location. So, in S45, node 1 judges whether the frame corresponding to said current play location is included in the downloaded data pieces, for instance, whether the range determined by offset locations corresponding to respective time points which correspond to the beginning time and ending time of the frame falls into the downloaded data pieces, and preferably, whether the range falls into the downloaded portion of each data piece. It is assumed that the intra frame a in FIG. 3 is at the beginning of the data portion, and thus, the frame corresponding to the location 00 hour: 00 minute: 00 second: 000 millisecond is the intra frame a. When the play of the intra frame a is finished, the frame corresponding to the next current play location 00 hour: 00 minute: 00 second: 040 millisecond is the intra frame b. It is assumed that the intra frame I in FIG. 3b is at the beginning of the data portion, then the frame corresponding to the location 00 hour: 00 minute: 00 second: 000 millisecond is the intra frame I. When the play of the intra frame I is finished, the frame corresponding to the next current play location 00 hour: 00 minute: 00 second: 040 millisecond is the combination of intra frame I and the forward predictive frame II.

Please refer to FIG. 3a. In S46, node 1 judges whether intra frame a is completely included in the downloaded data pieces.

In specific practice, said judgment can be implemented depending on whether the corresponding frame can be decode or read by the player. Frames which can not be decoded or read successfully are treated as frames of which the download has not been finished. Since this can be easily understood by those skill in the art, no more description is needed for it.

If the judging result in S46 shows that intra frame a is completely included in downloaded data pieces, decoding and other related processes will be implemented on the intra frame a in S47 for playing.

When the play of intra frame a is finished, the new current play location is changed correspondingly (for example, to 00 hour: 00 minute: 00 second: 040 millisecond, pointing to the frame header of the intra frame b), and then, S46 (judging whether the player can read the intra frame b successfully) and the follow-up steps are implemented with respect to said new current play location, wherein it is supported by the existing technology that the play location is changed automatically after one frame is played successfully.

If the judging result in S46 shows that, intra frame a is not completely included in the downloaded data frames, node 1 keeps the current play location unchanged, that is, S46 will be performed continuously till the download of intra frame a is finished completely, and then the processes such as decoding, etc. are implemented in S47 for playing. During said waiting process, users can be prompted that the current on-demand play is in a “Loading” state.

Please refer to FIG. 3b. In the compression manner where predictive frames are introduced, the frame corresponding to 00 hour: 00 minute: 00 second: 000 millisecond is the intra frame I. When the download of the intra frame I has not been finished, a negative judging result will be acquired from S46. Accordingly, S46 is repeated till the download of the intra frame I is finished. And then, the process proceeds to S47 to implement the decoding and the like processes on the intra frame I for playing.

Still refer to FIG. 3b. After the play of the intra frame I is finished, the new current play location corresponds to a frame group consisted of the intra frame I and the forward predictive frame II, and the node 1 implements the judgment in S46 with respect to said new current play location. If the download of the forward predictive frame II has not been finished completely at this moment (for example, the player is unable to read the forward predictive frame II successfully), the method may implement said judgment in S46 with respect to the new current play location continuously till the download of the forward predictive frame II is finished.

It is obvious that, in the fifth embodiment, users have bad experiences due to a long waiting time, because priorities of data pieces have no difference, exactly speaking, download priorities of data pieces are not associated with the current play location. The sixth embodiment optimizes download priorities of data pieces on this basis, and the detailed description is as follows.

### A Sixth Embodiment

### A Method for Controlling on-Demand Play of Non-Streaming Media Files According to the Second Aspect of the Present Invention, in which Download Priorities of Data Pieces are Determined According to the Current Play Location, and Neither a Frame Skip Pattern Nor a Drag and Drop Function is Supported

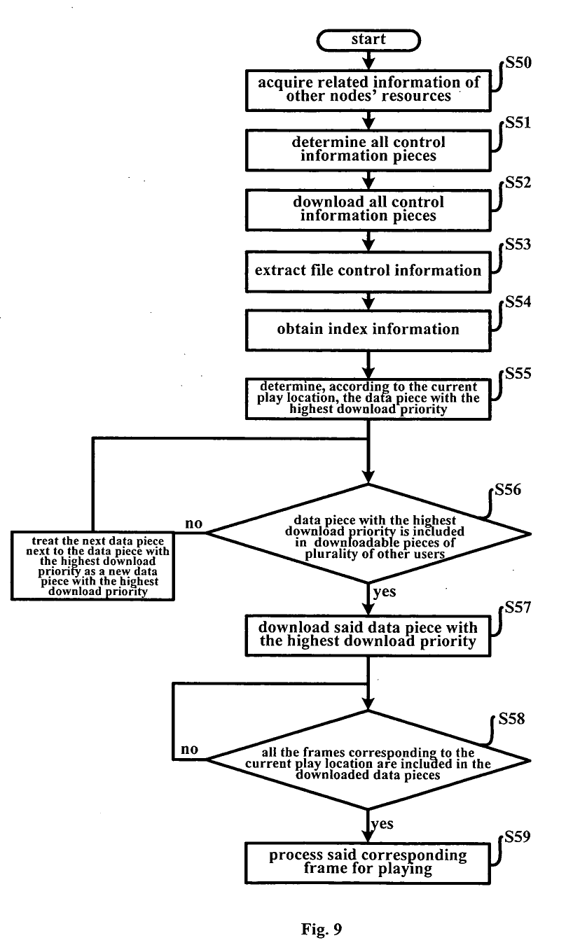

FIG. 9 is a flow chart illustrating a method for controlling on-demand play of non-streaming media files based on the P2P protocols in a node according to a sixth embodiment of the present invention, and a description will be given with reference to FIG. 9 and in conjunction with FIGS. 1, 3a and 3b.

The steps which are the same as those shown in FIG. 8 are still shown in FIG. 9 for giving a complete solution. But, their corresponding textual descriptions are relative simple, and related description parts of FIG. 8 can be referred to for the details.

According to the basic idea of the present invention, the acquisition of the file control information of media files, which is implemented according to resource related information of plurality of other nodes, is given the highest priority. Furthermore, the current play location is taken into consideration, to give priorities to data pieces appropriately. Preferably, the download priorities of data pieces are set according to their distance from the current play location in the direction of play of media files. The shorter the distance is, the higher the download priority of the data piece will be; while the longer the distance is, the lower the download priority of the data piece will be. Additionally, in response to that the current play location changes due to the play of one whole frame has been finished, download priorities of data pieces will change correspondingly. The shorter the distance from the new current play location is, the higher the download priority of the data piece will be; while the longer the distance is, the lower the download priority of the data piece will be. By doing so, one data piece with the highest download priority will be the first one to be downloaded among the un-downloaded data pieces. Accordingly, corresponding to the initial current play location 00 hour: 00 minute: 00 second: 000 millisecond of the media file, the first data piece is assigned with the highest priority, and download priorities of data pieces following it are descending one by one.

Next, the process proceeds to S56, wherein, node 1 judges, according to resource related information of other nodes, which mastered ever before, whether the data piece that has been assigned the highest priority in S55 is included in downloadable pieces of other nodes. Specifically, said judgment is implemented based on the information acquired from the directory server and resource information report messages (for instance, “Have” message) from other nodes.

If the judging result shows that said data piece with the highest priority is included in downloadable pieces of other nodes, node 1 determines one download source and downloads the data piece in S57. Said download source can be selected randomly. Preferably, node 1 chooses the node offering a highest download speed to it as the download source of the piece, among each node possessing the piece.

If the judging result shows that the data piece whose download has been given high priority is not included in the downloadable piece of other nodes, the node 1 treats the next data piece near the data piece whose download has been given high priority as a new data piece to be downloaded, and then goes back to the step S56 to implement corresponding judgment thereon.

Additionally, when the download speed exceeds the play speed, in other words, when the data piece with the highest priority falls into the downloaded data pieces, the method finds downwards from the data piece with the highest priority along the direction of file play till one data piece that has not been downloaded is found, and then, the data piece is determined as a new data piece with the highest priority. Then, it is judged whether there is any node can provide the download, if any, the new data piece with the highest priority is downloaded. The above situation may exist in the following cases:
network speed and resources situation are both ideal enough;
a user drags and drops in the direction opposite to the play direction based on other embodiments (fast rewind);
a user pauses or stops the play, and therefore, the downloader (downloading module) is allowed to go on working and the like.

This embodiment ensures the adaptability between a download object and the current play location. As a result, users' experiences are improved, as the buffering time needed by the play is shortened under the same network condition, and further the procedure of playing the media file while downloading becomes smoother.

### A Seventh Embodiment

### A Method For Controlling on-Demand Play of Non-Streaming Media Files According to the Second Aspect of the Present Invention, in which Download Priorities of Data Pieces are Determined According to the Current Play Location, and a Frame Skip Pattern is Supported But the Drag and Drop Function is not Supported

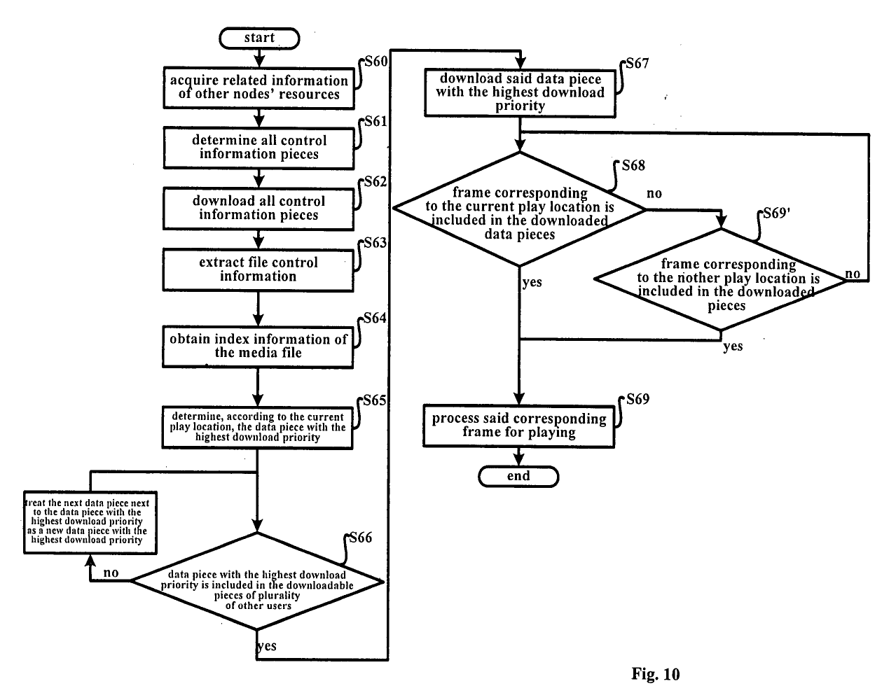

FIG. 10 is a flow chart illustrating a method for controlling on-demand play of streaming media files based on the P2P protocols in a node according to a seventh embodiment of the present invention, and a description will be given with reference to the FIG. 10 and in conjunction with FIGS. 1, 3a and 3b.

Please refer to FIG. 3a. It is assumed that the intra frame a in FIG. 3a is denoted by the play location “00 hour: 00 minute: 00 second: 00 millisecond” at the beginning of on-demand play of the file. The descriptions of steps S60-S68 can refer to the above embodiments.

In S68, if it is judged that the download of intra frame a is completely finished, the process will proceed to S69 so that the decoding and the like processes are implemented on the frame corresponding to the location “00 hour: 00 minute: 00 second: 00 millisecond”, i.e., the intra frame a for playing. When the play of the intra frame a is finished, a new current play location will point to the intra frame b, and then the judgment in S68 is implemented on the intra frame b.

Contrarily, if it is judged in S68 that intra frame a is not completely included in the downloaded data pieces (for instance, some of even none of the data information of intra frame a is included), node 1 preferably judges in S69′ whether there is another play location that the download of its corresponding frame has been finished among other play locations (corresponding to intra frames b, c, d, etc. respectively) after the current play location “00 hour: 00 minute: 00 second: 00 millisecond” according to said index information. The index information generally includes location information of intra frames (for instance, each intra frame's corresponding time point in the play period of the media file, mapping information for mapping information between said time point and corresponding file offset, number of piece where each intra frame is located and specific location thereof in the piece, or the like).

In a word, node 1 can locate at least some intra frames in the media file according to the index information. Additionally, the data information (for instance, from the i-th byte to the j-th byte of the N-th piece) corresponding to each intra frame can be determined in the data piece according to the bit rate of media file and piece size. Accordingly, the judgment in S69′ is implemented.

If there is no such play location, alternatively, the method returns to S68, to rejudge whether the download of the frame corresponding to the current play location “00 hour: 00 minute: 00 second: 000 millisecond”, i.e., the intra frame a has been finished.

If there is one or more such play locations, the method selects one play location from them as a new current play location alternatively, and the process proceeds to step S69 so that the decoding and the like processes are implemented on its corresponding frame, and then the corresponding frame is put into a buffer or played. Preferably, the method selects, from plurality of play locations satisfying a condition, the one closest to the current play location as the new current play location, and the decoding and the like processes are implemented on its corresponding frame, and then the corresponding frame is put into a buffer or played.

Alternatively, in S69′, node 1 may implement the following operations based on the index information:

1) judging whether the frame (the intra frame b) corresponding to the next play location (for instance, 00 hour: 00 minute: 00 second: 040 millisecond) next to the current play location is included in the downloaded data pieces;

1.1) if the judging result in 1) is yes, the location 00 hour: 00 minute: 00 second: 040 millisecond will be treated as the new current play location, and then the decoding and the like processes are implemented on the corresponding frame, i.e., the intra frame b, and then the intra frame b is put into a buffer or played;

1.2) if the judging result is no, it means that the download of several data pieces where the intra frame b is located has not been finished, and then, it is judged again whether a frame (frame c) corresponding a further next play location (for example, 00 hour: 00 minute: 00 second: 080 millisecond) is included in the downloaded data pieces;

1.2.1) if the judging result in 1.2) is no, the above judgment is implemented on a frame (intra frame d) corresponding to a more further next play location (00 hour: 00 minute: 00 second: 120 millisecond).

Once a positive judging result is acquired, the method will proceed to the step S69 so that the decoding and the like processes are implemented on the frame corresponding to the play location, and then the corresponding frame is put into a buffer or played.

The above has described, according to this embodiment, the on-demand play control of media files whose storing sequence for data portion is as shown in FIG. 3a. Hereunder, the on-demand play control of media files with predictive frames is illustrated with reference to FIG. 3b.

The current play location is set to 00 hour: 00 minute: 00 second: 000 millisecond, and its corresponding frame is the intra frame I. If the download of intra frame I has been finished, the decoding and the like processes are implemented thereon, and then the intra frame I is put into a buffer or played;

then, it is judged whether the download of the frame corresponding to a next play location 00 hour: 00 minute: 00 second: 040 millisecond, i.e., “intra frame I and forward predictive frame II” has been finished.
if the download has been finished, the forward predictive frame II will be decoded (combined with the intra frame I) and displayed, and the intra frame I is stilled in the buffer; it is judged whether the download of the frame corresponding to a more further next play location 00 hour: 00 minute: 00 second: 080 millisecond, “intra frame I and forward predictive frame III” has been finished, and the rest may be deduced by analogy;
if the download of “intra frame I and forward predictive frame II” has not been finished, it is further judged, according to the index information, whether the download of a next intra frame following the intra frame I in the download data pieces has been finished. If the download of the next intra frame has been finished, the decoding process will be implemented thereon.

It should be understood that, the frame corresponding to the play location mentioned in the text (including but not limited to the current play location or the next play location) is an intra frame, or an intra frame and its one or more predictive frames. In the frame skip pattern, the destination play location of the frame skip varies case by case due to the different description information in the index information, that is to say, if the index information has identified locations of all frames (regardless of intra frames or predictive frames) in the media file, the player will read the forward predictive frame II unsuccessfully when the download of the intra frame I has been finished but the download of the forward predictive frame II not finished, and therefore, the player can go to the play location corresponding to the forward predictive frame III, for example 00 hour: 00 minute: 00 second: 080 millisecond. Accordingly, it can be judged whether the download of the frame corresponding to the play location, “intra frame I and forward predictive frame III”, has been finished.

The seventh embodiment has a variation, the brief description of which has been given as follows. Please refer to FIG. 7.

It is assumed that the player is playing a forward predictive frame P1 currently, and then finds that the predictive frame P2 can not be read, which is possibly due to that P2 has wholly or partially fallen into the piece X's portion which has not been downloaded.

Then, the player calculates, according to the bit rate of the media file, one estimated value of the play period that the piece X actually occupies.

As compression algorithms will adjust the bit rate dynamically according to real situation of media files, that is, neither the time period corresponding to each data piece nor the number of frames included in the each data piece is certain, and the description information about these frames may be included in the index information.

For example, it is assumed that the piece size of the media file is 256 Kbyte and the average bit rate is 512 kbps, then each data piece occupies 4 seconds approximately. The computing manner of the average bit rate is: average bit rate=overall size of data portion/(division sign) the media file's play period given by the file control information.

It is assumed that the forward predictive frame P2 is at 5 minute 10 second, and therefore, the piece X which has not been downloaded is skipped over so as to go to for example 5 minute 14 second for example, and the index information is read and then the frame corresponding to 5 minute 14 second is queried. After the offset location of the frame in the file is acquired, it is queried whether the file piece corresponding to the offset location is the piece X. If so, it can be judged that the download of the frame must have not been finished, and then a next frame will be searched till one frame is located in the piece X+1 completely (say, both the offset location corresponding to the beginning time point and the offset location corresponding to the ending time point fall into the piece X+1), and the frame is Pm+1. Being acquired, Pm+1 is given to the decoder for decoding, and then is put into a buffer or played.

Another case is that, the frame corresponding to 5 minute 14 second is in Pm+3, and the former frames go to waste slightly. Preferably, several frames which have been downloaded can be searched backwards (along the direction towards the header of data portion) and then given to the decoder for decoding, thereby reducing the lost of downloaded frames.

### An Eighth Embodiment

### A Method for Controlling on-Demand Play of Non-Streaming Media Files According to the Second Aspect of the Present Invention, in which Download Priorities of Data Pieces are Determined According to the Current Play Location, and Both a Frame Skip Pattern and the Drag and Drop Function are Supported

When watching a media file, a user may need to choose one play location as a new current play location, and this is the so-called drag and drop function that we call.

Specifically, the user can make the play process go to a new play time point of the media file corresponding to the new play location through inputting user denoting information for denoting the chosen new play location, and then play sequentially. The implementing of inputting user denoting information may include (but not limited to): a. the user may drag the seek bar on the player to a designated location (corresponding to the new play location) with a mouse; b. the user may input one play time point corresponding to the new play location in the media file directly.

Still refer to FIG. 10. In this embodiment, the method further includes the step of “determining the new current play location according to the user denoting information” (not shown). Therefore, node 1 determines, according to the new current play location determined by the user denoting information, data pieces with high priority, and judges, in S68, whether the download of the frame corresponding to said new current play location has been finished.

After the user sends to a second on-demand play control means the user denoting information with computer peripherals, the determination of the new current play location can be implemented according to the following operations:

c. receiving the user denoting information; and

d. searching one play location corresponding to the time point according to the time point in the user denoting information and based on the index information, specifically, searching one intra frame corresponding to the time point.
If the time point just corresponds to one intra frame, the decoding and the like operations are implemented on the frame group where the intra frame is located;
if the time point does not correspond to an intra frame exactly, one intra frame closet to the time point is searched preferably, and more preferably, one intra frame closet to the time point and after the time point in terms of play sequence is searched.

Next, the determined frame group where the intra frame is located is decoded, specifically, S68 and follow-up operations are implemented on the frame group, and the detailed description thereof can refer to the each above embodiment.

The fourth embodiment has a variation, the brief description of which has been given as follows:
reading the index information, finding the frame closet to the time in the user denoting information, and acquiring the beginning and ending locations of the frame in the media file;
searching the data piece corresponding to said beginning and ending locations;
judging whether the download of the piece has been finished;
   if the download has not been finished, waiting until the download of the piece is finished (or implementing the frame skip automatically according to the third embodiment); and then, the data piece is treated as the one with the highest priority;
   if the download has been finished, reading the frame and giving it to the decoder for decoding, and the first data piece of which the download has not been finished is determined as the data piece with the highest priority.

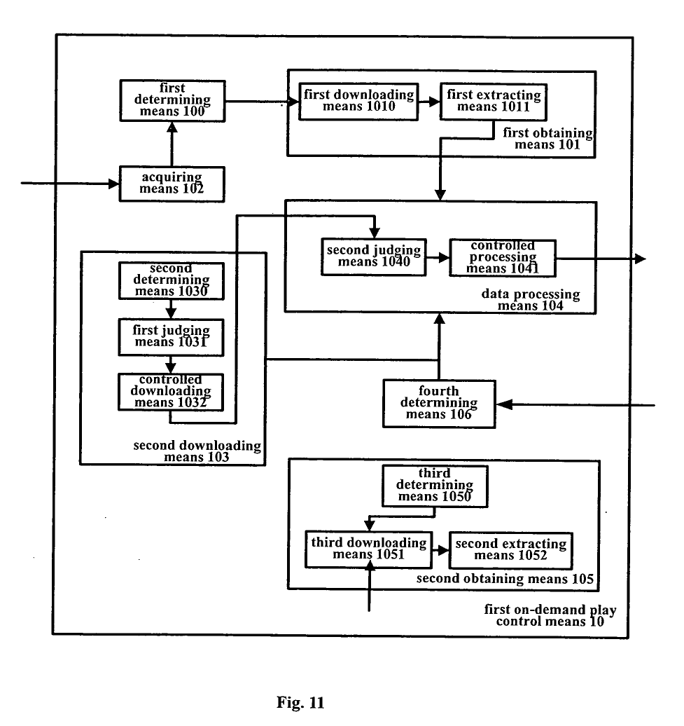

Hereinafter, a description of embodiments according to the third aspect of the present invention corresponding to different user experiences is given with reference to an apparatus block diagram as shown in FIG. 11. It should be understood that, embodiments corresponding to the first and third aspects will adopt same reference numbers. Furthermore, in some cases, some apparatus (for example, a fourth determining means 106) in FIG. 11 are not necessary, but for convenience, various apparatus appearing in each embodiment are generally shown in the FIG. 11.

A first on-demand play means 10 shown in FIG. 11 is generally configured in a user apparatus (for example, personal computer), and includes a first determining means 100, a first obtaining means 101, an acquiring means 102, a second downloading means 103, a data processing means 104, a second obtaining means 105 and a fourth determining means 106. Said first obtaining means 101 includes a first downloading means 1010, a first extracting means 1011; said second downloading means 103 includes a second determining means 1030, a first judging means 1031 and a controlled processing means 1032; said data processing means 104 includes a second judging means 1040 and a controlled processing means 1041; and said second obtaining means 105 includes a third determining means 1050, a third downloading means 1051 and a second extracting means 1052.

### A Ninth Embodiment

### An Apparatus for Controlling on-Demand Play of Streaming Media Files according to a third aspect of the present invention, in which data pieces are Downloaded Using Existing Techniques, Neither a Frame Skip Pattern Nor a Drag and Drop-Free Function is Supported

Please refer to FIG. 11 in combination with FIGS. 1, 3a and 3b. Herein, it is assumed that the node needing on-demand play of streaming media files is node 1 shown in FIG. 1.

The acquiring means 102 acquires resource related information of nodes 2, 3 and 4, and thus node 1 learns what pieces each other node has, so as to select download sources appropriately when downloading corresponding pieces. Because nodes 2, 3 and 4 are possibly downloading pieces belonging to the media file while acting as download sources for node 1, the acquiring means 102 not only acquires resource related information of other nodes from the directory server, but also acquires resource related information of the node(s) through resource information report messages from nodes 2, 3, 4 having established connection with node 1. There have been mature solutions supporting this, for example, after downloading one piece successfully, a node adopting the BT software sends “Have” messages including the piece's identification to each other node connected therewith, to show that it has the piece.

The first determining means 100 determines all control information pieces among plurality of pieces of the media file. Said determination operation is mainly based on the facts that, there are some constrains for size of the file control information of media files and piece size and the file control information is always located at a specific place (for instance, header of a media file) of media files. It is easy to understand that, if the file type of the media file has been determined according to description information of the media file (for example, the description information carried by a Torrent file) ahead, the range of size of the file control information will be more easily to be estimated. Taking the RMVB file as an example, its file control information is generally within 50 KB. Alternatively, the first determining means 100 may determine several pieces (the precondition that all control information can be included therein can then be satisfied), and generally, 1-2 pieces are enough to accommodate the whole file control information.

Consequently, the first downloading means 1010 downloads all determined control information pieces determined by the first determining means 100 to the local area, wherein download sources of each piece can be determined based on the resource related information of each other node acquired before.

Thereafter, the first extracting means 1011 extracts file control information of the media file from said all control information pieces, and the preparation for playing the streaming media file is basically completed after the player (playing module) loads the file control information.

There is no strict sequence relationship between operations implemented by the first obtaining means 101 and the second downloading means 103 respectively, that is, the download of data pieces can be implemented simultaneously with the acquisition of file control information or thereafter. In this embodiment, the download of data pieces is still implemented using the solutions, such as out-of-order download, giving priority to rare pieces, and the like used in the existing techniques as BT or eMule.

Therefore, when a user clicks for example a link to “Schindlers List”, the node 1 acquires the file control information according to the above steps, after the player loads the file control information, the default current play location is the beginning of the data portion of the media file, for example, 00 hour: 00 minute: 00 second: 000 millisecond. This is also consistent with people's habits of enjoying media files.

To display a picture corresponding to the current play location successfully, the player needs to decode the frame corresponding to the location. So, the second judging means 1040 judges whether the frame corresponding to said current play location is included in the downloaded data pieces. It is assumed that the intra frame a in FIG. 3 is at the beginning of the data portion, and thus, the frame corresponding to the location 00 hour: 00 minute: 00 second: 000 millisecond is the intra frame a. When the play of the intra frame a is finished, the frame corresponding to a next current play location is 00 hour: 00 minute: 00 second: 040 millisecond is the intra frame b. It is assumed that the intra frame I in FIG. 3b is at the beginning end of the data portion, then the frame corresponding to the location 00 hour: 00 minute: 00 second: 000 millisecond is the intra frame I. After the play of the intra frame I is finished, the frame corresponding to the next current play location 00 hour: 00 minute: 00 second: 040 millisecond is the intra frame I and the forward predictive frame II.

Please refer to FIG. 3a. The second judging means 1040 needs to judge whether intra frame a is completely included in the downloaded data pieces. Said judgment can be implemented based on the following facts:

1. the location (for example, i-th byte) corresponding to a time point in the data portion can be calculated according to the time point corresponding to the current play location and the bit rate of the media file;

2. it is possible to locate said corresponding frame (for example, from j-th byte to k-th byte of N-th piece) in the data piece exactly, as the piece size and the frame length are known, and the pieces have their respective labels. By doing so, one judging result can be obtained.

If the judging result shows that the complete intra frame a is included in downloaded data pieces, the decoding and other related processes are implemented on the intra frame a by the controlled processing means 1041 for playing.

When the play of the intra frame a is finished, the new current play location is changed correspondingly (for example, 00 hour: 00 minute: 00 second: 040 millisecond, pointing to the frame header of the intra frame b), and then, the second judging means 1040 implements the judging operation on said new current play location, wherein it is supported by the existing technology that the play location is changed automatically after one frame is played successfully.

If the judging result shows that, the complete intra frame a is not included in the downloaded data frames, the node 1 keeps the current play location unchanged, that is, said second judging means 1040 implements the judgment continuously till the download of intra frame a is finished absolutely, and then the controlled processing means 1031 implements processes such as decoding, etc. thereon for playing. During said waiting process, users can be prompted that the current on-demand play is in a “Loading” state.

Please refer to FIG. 3b. In the compression manner where predictive frames are introduced, the frame corresponding to 00 hour: 00 minute: 00 second: 000 millisecond is the intra frame I. When the download of the intra frame I has not been finished, the second judging means 1040 will acquire a negative judging result. Accordingly, the second judging means 1040 judges with respect to the current location repeatedly till the download of the intra frame I is finished. And then, the controlled processing means 1041 implements the decoding and the like processes on the intra frame I, and puts it into a buffer or plays it.

Still refer to FIG. 3b. After the play of the intra frame I is finished, the new play location corresponding to a frame group consisted of the intra frame I and the forward predictive frame II, and the second judging means 1040 implements the judgment with respect to the new play location. If the download of the forward predictive frame II has not been finished at this moment, the second judging means 1040 may implement said judgment with respect to the new play location continuously till the download of the forward predictive frame II is finished.

As index information is not necessary for playing non-streaming media files, index information pieces can be downloaded with data pieces out of order in this embodiment, or not downloaded. Accordingly, the second obtaining means 105 is optional.

### A Tenth Embodiment

### An Apparatus for Controlling on-Demand Play of Streaming Media Files According to the Third Aspect of the Present Invention, in which Download Priorities of Data Pieces are Determined According to the Current Play Location, and Neither a Frame Skip Nor a Drag and Drop Function is Supported

According to the basic idea of the present invention, the acquisition of file control information of media files, which is implemented by the first determining means 100 and the first obtaining means 101 according to resource related information of plurality of other nodes, is given the highest priority. Furthermore, the current play location is taken into consideration by the second determining means 1030 to give priorities to data pieces appropriately. Preferably, the download priorities of data pieces are set according to their distance from the current play location in the direction of play of media files. The shorter the distance is, the higher the download priority of the data piece will be; while the longer the distance is, the lower the download priority of the data piece will be. Additionally, in response to that the current play location changes due to the play of one whole frame has been finished, download priorities of data pieces will change correspondingly. The shorter the distance from the new current play location is, the higher the download priority of the data piece is; while the longer the distance is, the lower the download priority of the data piece is. By doing so, one data piece with the highest download priority will be the first one to be downloaded among un-downloaded data pieces. So, corresponding to the initial current play location 00 hour: 00 minute: 00 second: 00 millisecond in the media file, the data pieces with the highest priority is located in intra frame a as shown in FIG. 3a and the intra frame I as shown in FIG. 3b.

Then, the first judging means 1031 judges, according to the resource related information of other nodes mastered by the acquiring means 102, whether the data piece with the highest priority, determined by the second determining means 1030, is included in downloadable pieces of other nodes. Specifically, said judgment is implemented based on the information acquired from the directory server and resources information report messages (for instance, “Have” message) from other nodes.

If the judging result shows that said data piece with the highest priority is included in downloadable pieces of other nodes, the controlled downloading means 1032 determines one download source and downloads the data piece. Said download source can be selected randomly. Preferably, the controlled downloading means 1032 chooses the node offering a highest download speed to node 1 as the download source of the piece among those nodes possessing the piece.

If the judging result shows that the data piece with the highest priority is not included in the downloadable pieces of other nodes, the first judging means 1031 treats the next data piece near the data piece with the highest priority as a new data piece with the highest priority, and then implements said judgment thereon.

Additionally, when the download speed exceeds the play speed, in other words, when the download of the data piece with the highest priority falls into the data pieces which have already been downloaded, the method finds downwards from the data piece with the highest priority along the direction of file play till one data piece that has not been downloaded is found, and then, the data piece will be determined as a new data piece with the highest priority. Further, it is determined whether there is any node can support the download, if any, the new data piece whose download is given priority is downloaded. The above situation may exist in the following cases:
network speed and resources situation are both ideal enough;
a user drags and drops in the direction opposite to the play direction based on other embodiments (fast rewind);
a user pauses or stops the play, and therefore, the downloader (downloading module) is allowed to go on working and the like.

### An Eleventh Embodiment

### An Apparatus for Controlling on-Demand Play of Streaming Media Files According to the Third Aspect of the Present Invention, in which Download Priorities Of Data Pieces are Determined According to the Current Play Location, and a Frame Skip Pattern Is Supported But a Drag and Drop Function is not Supported

In this embodiment, in order to support the frame skip pattern, the second obtaining means 105 needs to obtain the index information of the media file, and there is no strict sequence relationship between the operation of obtaining the index information and the operation of obtaining the file control information.

The index information can be acquired in anyone of the following manners:

a. computing index information location according to file control information, thereby enabling the third determining means 1050 to determine all index information pieces; after the third downloading means 1051 downloads all index information pieces, the second extracting means 1052 extracts index information therefrom;

b. learning the file type of the media file according to the description information in the Torrent file, thereby computing the index information location roughly to determine all index information pieces and then downloading and extracting the index information.

The procedure of acquiring the index information is based on the following facts: there are some constrains for piece size and size of index information of medial files, and the index information is always located at a specific location (for instance, tail) of the media file. The sizes of index information of different types of media files are dramatically different. As an example, index information of AVI and WMV formats is usually around 1-5 MByte, while that of RMVB format is relative small, about 256-500 Kbyte. It is easy to understand that, the determination of file type is helpful to estimate the size of index information more easily and thus determine all index information pieces.

A description about how to implement the frame skip during on-demand play of streaming media file according to the eleventh embodiment is given as follows.

Please refer to FIG. 3a. It is assumed that the intra frame a in the FIG. 3 is denoted by the play location “00 hour: 00 minute: 00 second: 00 millisecond” at the beginning of on-demand play of the file.

If it is determined by the second judging means 1040 that the complete intra frame a is included in the downloaded data pieces, the controlled processing means 1041 is instructed to implement decoding and the like processes on the frame corresponding to the location “00 hour: 00 minute: 00 second: 00 millisecond”, i.e., the intra frame a for playing. When the play of the intra frame a is finished, the new current play location will point to the intra frame b, and then the second judging means 1040 implements the above judgment on the intra frame b.

Contrarily, if the second judging means 1040 judges that intra frame a is not completely included in the downloaded data pieces (for instance, some of even none of the data information of intra frame a is included), the second judging means 1040 preferably judges, according to said index information, whether there is another play location that the download of its corresponding frame has been finished among other play locations (corresponding to intra frames b, c, d, etc. respectively) after the current play location “00 hour: 00 minute: 00 second: 00 millisecond”. The index information generally includes location information of intra frames (for instance, corresponding time point of each intra frame in the play period of the media file, mapping information between said time point and corresponding file offset, number of piece where each intra frame is located and specific location thereof in the piece, or the like).

In a word, the node 1 can locate all intra frames in the media file according to the index information. Additionally, the data information (for instance, from the i-th byte to the j-th byte of the N-th piece) corresponding to the each intra frame can be determined in the data piece according to the bit rate of media file and the piece size, thereby enabling the second judging means 1040 to implement the above judgment.

If there is no such play location, alternatively, the second judging means 1040 re-judges whether the download of the frame corresponding to the current play location “00 hour: 00 minute: 00 second: 00 millisecond”, i.e., the intra frame a has been finished. If there are one or more such play locations, alternatively, the controlled processing means 1041 selects one play location from them as a new current play location, implements the decoding and the like processes on the corresponding frame, and puts it into a buffer or plays it. Preferably, it selects, from plurality of play locations satisfying a condition, the one closest to the current play location as the new current play location, and the decoding and the like processes are implemented thereon, and then the corresponding frame is put into a buffer or played.

Alternatively, node 1 may implement the following operations based on the index information:

1) the second judging means 1040 judges whether the frame (the intra frame b) corresponding to the next play location (for instance, 00 hour: 00 minute: 00 second: 040 millisecond) of the current play location is included in the downloaded data pieces;

1.1) if the judging result in 1) is yes, the controlled processing means 1041 treats the location 00 hour: 00 minute: 00 second: 040 millisecond as the new current play location, implements the decoding and the like processes on the corresponding frame, i.e., the intra frame b, and puts it into a buffer or plays it;

1.2) if the judging result is no, it means that the download of several data pieces where the intra frame b is located has not been finished, and then, the second judging means 1040 re-judges whether a frame (frame c) corresponding a further next play location (for example, 00 hour: 00 minute: 00 second: 080 millisecond) is included in the downloaded data pieces;

1.2.1) if the judging result in 1.2) is no, the second judging means 1040 implements the above judgment on the frame (intra frame d) corresponding to the more further next play location (00 hour: 00 minute: 00 second: 120 millisecond).

Once a positive determining result is acquired, the controlled processing means 1041 implements the decoding and the like processes on the frame corresponding to the play location, and puts it into a buffer or plays it.

The above has described, according to this embodiment, the on-demand play control of media files whose storing sequence for data portion is as shown in FIG. 3a. Hereunder, the on-demand play control of media files with predictive frames is illustrated with reference to FIG. 3b.

The current play location is set to 00 hour: 00 minute: 00 second: 000 millisecond, and its corresponding frame is the intra frame I. If the download of intra frame I has been finished, the decoding and the like processes are implemented thereon, and then it is put into a buffer or played;

then, it is determined whether the download of the frame(s) corresponding to the next play location 00 hour: 00 minute: 00 second: 040 millisecond, i.e., “intra frame I and forward predictive frame II” has bee finished;
if the download has been finished, the forward predictive frame II will be decoded (combined with the intra frame I) and displayed, and the intra frame I is still in the buffer; it is judged whether the download of the frame corresponding to the further next play location 00 hour: 00 minute: 00 second: 080 millisecond, “intra frame I and forward predictive frame II” has been finished, and the rest may be deduced by analogy;
if the download of “intra frame I and forward predictive frame II” has not been finished, the second judging means 1040 re-judges whether the download of the next intra frame after the intra frame I in the download data pieces has been finished according to the index information; if the download of the next intra frame has been finished, the decoding process will be implemented thereon for playing.

It should be understood that, the frame corresponding to the play location (including but not limited to the current play location or the next play location) mentioned in the text is a intra frame, or a intra frame and its one or more predictive frames. In the frame skip pattern, the destination play location of frame skip varies case by case due to the different description information in the index information, that is, if the index information has identified locations of all frames (regardless of intra frames or predictive frames) in the media file, and the player can go to the play location corresponding to the forward predictive frame III, for example 00 hour: 00 minute: 00 second: 080 millisecond when the download of the intra frame I is finished but the download of the forward predictive frame II is not. Accordingly, the second judging means 1040 judges whether the download of the frame corresponding to the play location, i.e., “the intra frame I and forward predictive frame III”, has been finished.

The eleventh embodiment has a variation, the brief description of which is given as follows. Please refer to FIG. 7 which illustrates download situation of the data portion of media files corresponding to said variation. A dashed line refers to the situation that the download has not been finished.

It is assumed that the player is playing a forward predictive frame P1 currently, and finds that the predictive frame P2 can not be read, which is possibly due to that P2 has wholly or partially fallen into the piece X's portion which has not been downloaded.

So, the player calculates one estimated value of the play period that the piece X actually occupies according to the bit rate of the media file.

As compression algorithms will adjust the bit rate dynamically according to real situation of the media file, that is, neither the time period corresponding to each data piece nor the number of frames included in the each data piece is not certain, and the description information about these frames may be included in the index information.

For example, it is assumed that the piece size of the media file is 256 Kbyte and the average bit rate is 512 kbps, then each data piece occupies 4 seconds approximately. The computing manner of the average bit rate is: average bit rate=overall size of data portion/(division sign) the media file's play period given by the file control information.

It is assumed that P2 is at 5 minute 10 second, and therefore, the piece X which has not been downloaded is skipped over so as to go to 5 minute 14 second for example, and then query the frame corresponding to 5 minute 14 second by reading the index information. After the offset location of the frame in the file is acquired, it is queried whether the file piece corresponding to the offset location is the piece X. If so, the download of the frame must have not been finished, and then the next frame will be searched till one frame is located in the piece X+1 completely (both the offset location corresponding to the beginning time point and the offset location corresponding to the ending time point fall into the piece X+1), and the frame is Pm+1.

After acquired, the P3 is given to the decoder to be decoded.

Another case is that, the frame corresponding to 5 minute 14 second is in Pm+3, and the former frames go to waste slightly. Preferably, several frames which have been downloaded can be searched backwards (along the direction towards the header of data portion) and then given to the decoder for decoding, thereby reducing the lost of downloaded frames.

### A Twelfth Embodiment

### A Method for Controlling on-Demand Play of Streaming Media Files According to the Third Aspect of the Present Invention, in which Download Priorities of Data Pieces are Determined According to the Current Play Location, and Both a Frame Skip Pattern And a Drag and Drop Function are Supported

When watching a media file, a user may need to choose one play location as a new current play location, and this is the so-called drag and drop function that we call.

Specifically, the user can make the play process go to the new play time point of the media file corresponding to the new play location through inputting user denoting information for denoting the chosen new play location, and then play sequentially. The implementing manner of inputting user denoting information may include (but not limited to): a. the user may drag the seek bar on the player to the designated location (corresponding to the new play location) with a mouse; b. the user may input one play time point corresponding to the new play location in the media file directly.

In this embodiment, the fourth determining means 106 needs to determine the new current play location according to the user denoting information. Consequently, the second determining means 1030 determines, data pieces with the high priority according to the new current play location determined by the user denoting information; and the second judging means 1040 judges whether the download of the frame corresponding to said new current play location has been finished.

After the user sends to the first on-demand play control means the user denoting information with computer peripherals, the determination of the new current play location can be implemented according to the following operations:
the fourth determining means 106 receives the user denoting information;
next, the fourth determining means 106 searches one play location corresponding to the time point according to the time point in the user denoting information and based on the index information, specifically, searches one intra frame corresponding to the time point.
   If the time point just corresponds to one intra frame, the controlled processing means 1041 implements the decoding and the like operations on the frame group where the intra frame is located;
   if the time point does not correspond to a intra frame exactly, one intra frame closest to the time point is searched preferably, and more preferably, one intra frame closest to the time point and after the time point in terms of play sequence is searched.

Next, the frame group where the determined intra frame is located is decoded, and the details can be referred to the descriptions of every embodiment.

The twelfth embodiment has a variation, the brief description of which is given as follows:
reading the index information, finding the frame closet to the time in the user denoting information, and acquiring the beginning and ending locations of the frame in the media file;
   searching the data piece corresponding to said beginning and ending locations;
   judging whether the download of the piece has been finished;
      if the download has not been finished, waiting until the download of the piece is finished (or implementing frame skip automatically according to the third embodiment); and then, the data piece is determined as the one with the highest priority;
      if the download has been finished, reading the frame and giving it to the decoder for decoding, and the first data piece of which the download has not been finished is determined as the data piece with the highest priority.

Similar with the third aspect of the present invention, the fourth aspect of the present invention has several embodiments corresponding user experiences with different optimization degrees, described in detail as follows.

### A Thirteenth Embodiment

### An Apparatus for Controlling on-Demand Play of Non-Streaming Media Files According to a Fourth Aspect of the Present Invention, in which Data Pieces are Downloaded Using Existing Techniques, and Neither a Frame Skip Pattern Nor a Drag and Drop-Free Function is Supported

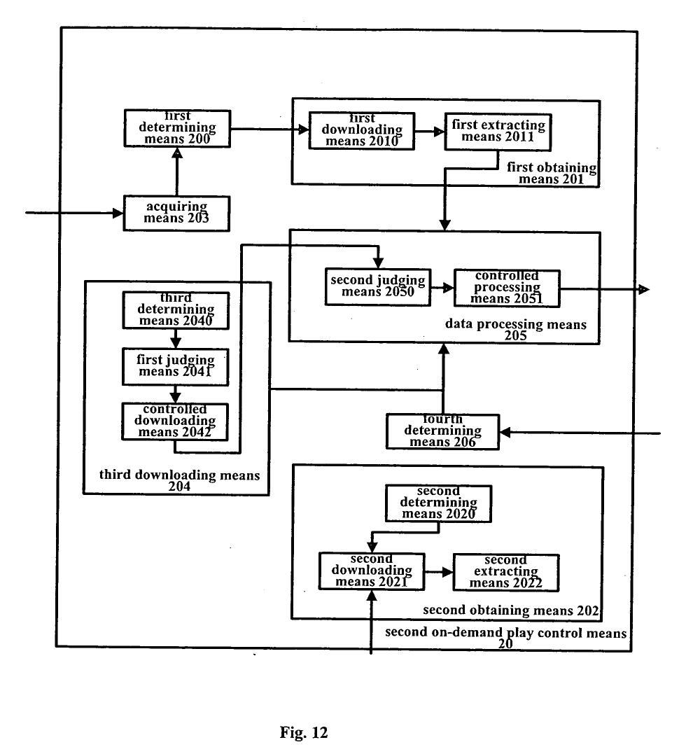

FIG. 12 is a block diagram illustrating a second on-demand play apparatus for controlling on-demand play of streaming media files based on the P2P protocols in a node according to a fourth embodiment of the present invention, and a description will be given with reference to the FIG. 12 and in conjunction with FIGS. 1, 3a and 3b. It is assumed that the node needing on-demand play of streaming media files is the node 1 shown in FIG. 1. For convenience, all apparatus possibly appearing in the following each embodiment are shown in FIG. 12. The second on-demand play control means 20 as shown in the figure includes a first determining means 200, a first obtaining means 201, a second obtaining means 202, an acquiring means 203, a third downloading means 204, a data processing means 205 and a fourth determining means 206, wherein:

said first obtaining means 201 includes a first downloading means 2010 and a first extracting means 2011; said second obtaining means includes a second determining means 2020, a second downloading means 2021 and a second extracting means 2022; said third downloading means 204 includes a third determining means 2040, a first determining means 2041 and a controlled downloading means 2042; and said data processing means 205 includes a second judging means 2050 and a controlled processing means 2051.

The acquiring means 203 acquires resource related information of nodes 2, 3 and 4, and thus the node 1 learns what pieces each other node has, so as to select download sources appropriately when downloading corresponding pieces. The acquiring means 203 not only acquires related information of other nodes' resources from the directory server, but also acquires resource related information of the node(s) which is from nodes 2, 3 and 4 and has established connection (s) with the node 1 through resources information report messages, because nodes 2, 3 and 4 are possibly downloading pieces belonging to the media file while playing as download sources. There have been mature solutions supporting this, for example, after downloading one piece successfully, a node adopting the BT software sends “Have” messages including the piece's identification to each other node connected therewith, to show that it has the piece.

The first determining means 200 determines all control information pieces among plurality of pieces of the media file. The possibility of the decision operation is mainly based on that, there are some constrains for size of file control information of media file and piece size, and the file control information is always located at a specific place (for instance, header) of media file. It is easy to be understood that, if its file type has been determined according description information of the media file (for example, the description information carried by a Torrent file) ahead, the range of size of file control information will be more easily to be estimated. Alternatively, the node may determine several pieces (the precondition that all control information can be included therein should be satisfied) roughly, and generally, to include all file control information pieces, 1-2 pieces are enough.

Next, the first downloading means 2010 downloads all determined control information pieces determined by the first determining means 200 to local area, wherein download sources of each piece can be determined based on the related information of each other node's resources which is acquired before.

And then, the first extracting means 2011 extracts the file control information of the media file from said all control information pieces.

Said second acquiring means 202 is in charge of acquiring index information of the media file. Specifically, the implementation may include that the second downloading means 2021 can download said all index information pieces after the second determining means 2020 determines all index information pieces, and then the second extracting means 2022 extracts the index information therefrom. The exact determination of index information pieces can be implemented based on the index information calculated from the file control information after the file control information is acquired, or all the index information pieces can be determined roughly according to the file type. In other words, the download of index pieces and the download of control information can be downloaded at the same time, without precedence order.

Likewise, the download of data pieces implemented by the third downloading means 204 can implement in simultaneous with the download of control information pieces and index information pieces, or after the download of the control information pieces. In this embodiment, the download of data pieces is still implemented using the solutions, such as out-of-order download, giving priority to rare pieces, and the like used in the existing techniques as BT or eMule.

Therefore, when a user clicks for example a link to “Schindlers List”, the node 1 acquires the file control information and index information according to the above steps, and the default current play location is the beginning of data portion of the media file, for example, 00 hour: 00 minute: 00 second: 000 millisecond after the player loads the file control information and index information. This is also consistent with people's habits of enjoying media files.

To display a picture corresponding to the current play location successfully, the player needs to decode the frame corresponding to the location. So, the second judging means 205 judges whether the frame corresponding to said current play location is included in the downloaded data pieces, for instance, whether the range determined by offset locations corresponding to respective time points which correspond to the beginning time and ending time of the frame falls into the downloaded data pieces, and preferably, whether the range falls into the downloaded portion of each data piece. It is assumed that the intra frame a in FIG. 3 is at the beginning end of the data portion, and thus, the frame corresponding to 00 hour: 00 minute: 00 second: 000 millisecond is the intra frame a. After the play of the intra frame a is finished, the frame corresponding to the next current play location as 00 hour: 00 minute: 00 second: 040 millisecond is the intra frame b. It is assumed that the intra frame I in FIG. 3b is at the beginning end of the data portion, then the frame corresponding to the location 00 hour: 00 minute: 00 second: 000 millisecond is the intra frame I. After the play of the intra frame I is finished, the frame corresponding to the next current play location 00 hour: 00 minute: 00 second: 040 millisecond is the intra frame I and the forward predictive frame II.

Please refer to FIG. 3a. The second judging means 2050 needs to judge whether a complete intra frame a is included in the downloaded data pieces. Said judgment can be implemented based on the following facts:

1. the location (for example, i-th byte) corresponding to a time point in the data portion can be calculated according to the time point corresponding to the current play location and the bit rate of the media file;

2. it is possible to locate said corresponding frame (for example, from i-th byte to j-th byte of N-th piece) in the data piece exactly, as the piece size and frame length are known, and the pieces have their respective labels.

Said judgment can be concluded according to whether the corresponding frame can be read by the player. That frames which can not be read successfully are treated as those of which the download has not been finished.

If the judging result of the second judging means 2050 shows that the complete intra frame a is included in download data pieces, the controlled processing means 2051 is instructed to implement the decoding and the like processes on the intra frame a for playing.

After the play of the intra frame a has been finished, the new current play location is changed correspondingly (for example, 00 hour: 00 minute: 00 second: 040 millisecond, pointing to the frame header of the intra frame b), and then, the second judging means 2050 implements corresponding judgment on said new current play location, wherein that the play location is changed automatically after one frame is played successfully is supported by the existing technology.

If the judging result of the second judging means 2050 shows that, the complete intra frame a is not included in the downloaded data pieces, the node 1 keeps the current play location unchanged, that is, the second judging means 2050 is performed continuously till the download of intra frame a has been finished absolutely, and then the processes such as decoding, etc. are implemented thereon by the controlled processing means 2051 for playing. During said waiting process, users can be prompted that the current on-demand play is in a “Loading” state.

Please refer to FIG. 3b. In the compression manner where predictive frames are introduced, the frame corresponding to 00 hour: 00 minute: 00 second: 000 millisecond is the intra frame I. When the download of the intra frame I has not been finished, the second judging means 2050 will acquire a negative judging result. Accordingly, the second judging means 2050 judges with respect to the current location repeatedly till the download of the intra frame I is finished. And then, the controlled processing means 2051 is instructed to implement the decoding and the like processes on the intra frame I to play it.

Still refer to FIG. 3b. After the play of the intra frame I is finished, the new current play location corresponds to a frame group consisted of the intra frame I and the forward predictive frame II, and the second judging means 2050 implements the judgment in S46 with respect to said new current play location. If the download of the forward predictive frame II has not been finished at this moment (for example, the player is unable to read the forward predictive frame II successfully), the second judging means 2050 may implement said judgment in S46 with respect to the new current play location continuously till the download of the forward predictive frame II has been Finished.

### A Fourteenth Embodiment

### An Apparatus for Controlling on-Demand Play of Non-Streaming Media Files According to a Fourth Aspect of the Present Invention, in which Download Priorities of Data Pieces are Determined According to the Current Play Location, and Neither a Frame Skip Nor a Drag and Drop Function is Supported

According to the basic idea of the present invention, the acquisition of file control information of media files, which is implemented by the first determining means 200 and the first obtaining means 201 according to resource related information of plurality of other nodes, is given a highest priority. Furthermore, data pieces whose download should be given high priority can be determined according to the current play location by the third determining means 2040, to give priorities to data pieces appropriately. Preferably, the download priorities of data pieces are set according to their distance from the current play location in the direction of play of media files. The shorter the distance is, the higher the download priority of the data piece is; while the longer the distance is, the lower the download priority of the data piece is. Additionally, in response to that the current play location changes due to the play of one whole frame has been finished, download priorities of data pieces will change correspondingly. The shorter the distance from the new current play location is, the higher the download priority of the data piece is; while the longer the distance is, the lower the download priority of the data piece is. By doing so, one data piece (with the highest download priority) whose download should be given high priority is selected from data pieces which have not been downloaded. So, corresponding to the initial current play location 00 hour: 00 minute: 00 second: 00 millisecond in the media file, the data pieces whose download has given high priority are respectively located at the intra frame a as shown in FIG. 3a and the intra frame b as shown in FIG. 3b.

And then, the first judging means 2041 judges, according to related information of other nodes' resources, which is mastered by the node 1, whether the data piece whose download has been given high priority before is included in downloadable pieces of other nodes. Specifically, said judgment is implemented based on the information acquired from the directory server and resources information report messages (for instance, “Have”) from other nodes.

If the judging result shows that said data piece whose download has been given priority is included in downloadable pieces of other nodes, the controlled downloading means 2042 determines one download source and downloads the data piece. Said download source can be selected randomly. Preferably, the node 1 chooses the node offering a highest download speed to it as the download source of the piece among each node having the piece.

If the judging result shows that the data piece whose download has been given high priority is not included in the downloadable piece of other nodes, the first judging means 2041 treats the next data piece near the data piece whose download has been given high priority as a new data piece to be downloaded, and then implements said judgment on the new data piece whose download has been given high priority.

Additionally, when the download exceeds the play speed, in other words, the download of the data piece whose download has given high priority may have been included in the downloaded data pieces, the method searches downwards from the data piece whose download has been given high priority along the direction of file play till one data piece that has not been downloaded is found, and then, the data piece is determined as a new data piece whose download should be given priority. Then, it is determined whether there is any node providing the download, if any, the new data piece whose download has been given priority is downloaded. The above situation may exist in the following situations:
network speed and resources situation are both ideal enough;
a user drags and drops in the direction opposite to the play direction based on other embodiments (fast rewind);
a user pauses or stops the play, and therefore, the downloader (module) is allowed to go on working and the like.

### A Fifteenth Embodiment

### An Apparatus for Controlling on-Demand Play of Streaming Media Files According to The Fourth Aspect of The Present Invention, in Which Download Priorities of Data Pieces are Determined According to the Current Play Location, and a Frame Skip Pattern is Supported But a Drag and Drop Function is not Supported

Please refer to FIG. 3a. It is assumed that the intra frame a in the FIG. 3 is denoted by the play location “00 hour: 00 minute: 00 second: 00 millisecond” at the beginning of on-demand play of the file.

If it is judged by the second judging means 2050 that the complete intra frame a is included in the downloaded data pieces, the controlled processing means 2051 is instructed to implement decoding and the like processes on the frame corresponding to “00 hour: 00 minute: 00 second: 00 millisecond”, i.e., the intra frame a for playing. After the play of the intra frame a is finished, a new current play location points to the intra frame b, and then the second judging means 2050 implements the above judgment on the intra frame b.

Contrarily, if the second judging means 2050 judges that the complete intra frame a is not included in the downloaded data pieces (for instance, all or some of the data information of the intra frame a has not been included), the second judging means 2050 preferably judges, according to said index information, whether there is another play location that the download of its corresponding frame has been finished among other play locations (corresponding to intra frames b, c, d, etc.) after the current play location “00 hour: 00 minute: 00 second: 00 millisecond”. The index information generally includes location information of intra frames (for instance, each intra frame's corresponding time point in the play period of the media file, mapping information between said time point and corresponding file offset, number of piece where each intra frame is located and specific location thereof in the piece, or the like).

In a word, the node 1 can locate all intra frames in the media file according to the index information. Additionally, the data information (for instance, from the i-th byte to the j-th byte of the N-th piece) corresponding to the each intra frame can be determined in the data piece according to the bit rate of media file and piece size.

If there is no such play location, the second judging means 2050 re-judges whether the download of the frame corresponding to the current play location “00 hour: 00 minute: 00 second: 00 millisecond”, i.e., the intra frame a has been finished.

If there is one or more such play locations, the controlled processing means 2051 selects one play location from them as a new current play location alternatively, implements the decoding and the like processes on the corresponding frame for playing. Preferably, from plurality of play locations satisfying a condition, the one closest to the current play location as the new current play location is selected, and the decoding and the like processes are implemented thereon for playing.

Alternatively, the node 1 may implement the following operations based on the index information:

1) the second judging means 2050 judges whether the frame (intra frame b) corresponding to the next play location (for instance, 00 hour: 00 minute: 00 second: 040 millisecond) of the current play location is included in the downloaded data pieces;

1.1) if the judging result in 1) is yes, the controlled processing means 2051 treats 00 hour: 00 minute: 00 second: 040 millisecond as the new current play location, implements the decoding and the like processes on the corresponding frame, i.e., the intra frame b for playing;

1.2) if the judging result is no, it means that the download of several data pieces where the intra frame b is located has not been finished, and then, the second judging means 2050 re-judges whether a frame (frame c) corresponding a further next play location (for example, 00 hour: 00 minute: 00 second: 080 millisecond) is included in the downloaded data pieces;

1.2.1) if the judging result in 1.2) is no, the second judging means 2050 implements the above judgment on the frame (intra frame d) corresponding to the more further next play location (00 hour: 00 minute: 00 second: 120 millisecond).

Once a positive determining result is acquired, the controlled processing means 2051 implements the decoding and the like processes on the frame corresponding to the play location, and puts it into a buffer or plays it.

The above has described, according to this embodiment, the on-demand play control of media files whose storing sequence for data portion is as shown in FIG. 3a. Hereunder, the on-demand play control of media files with predictive frames is illustrated with reference to FIG. 3b.

The current play location is set to 00 hour: 00 minute: 00 second: 000 millisecond, and its corresponding frame is the intra frame I. If the download of intra frame I has been finished, the decoding process is implemented thereon, and then it is put into a buffer or played;

then, it is determined whether the download of the frame corresponding to the next play location 00 hour: 00 minute: 00 second: 040 millisecond, i.e., “intra frame I and forward predictive frame II” has bee finished;
if the download of the corresponding frame “intra frame I and forward predictive key II” has been finished, the forward predictive frame II is decoded (combined with the intra frame I) and displayed, and the intra frame I is still in the buffer; it is judged whether the download of the frame corresponding to the further next play location 00 hour: 00 minute: 00 second: 080 millisecond, “intra frame I and forward predictive frame II” has been finished, and the rest may be deduced by analogy;
if the download of the corresponding frame “intra frame I and forward predictive frame II” has not been finished, it is further judged whether the download of the next intra frame after the intra frame II in the download data pieces has been finished according to the index information; if the download of the next intra frame has been finished, the decoding process is implemented thereon.

It should be appreciated that, the frame corresponding to the play location (including but not limited to the current play location or the next play location) mentioned in the text is one intra frame, or one intra frame and its one or more predictive frames. In the frame skip pattern, the destination play location of frame skip is different depending on different description information in the index information, that is, if the index information has identified locations of all frames (regardless of intra frames or predictive frames) in the media file, and the player can go to the play location corresponding to the forward predictive frame III, for example 00 hour: 00 minute: 00 second: 080 millisecond when the download of the intra frame I has been finished but the download of the forward predictive frame II not finished. Accordingly, it is judged whether the download of the frame corresponding to the play location, “intra frame I and forward predictive frame II”, has been finished.

The fifteenth embodiment has a variation, the brief description of which is given as follows. Please refer to FIG. 7.
It is assumed that the player is playing the forward predictive frame P1 currently, and finds that the predictive frame P2 can not be read, which is possibly due to that all or some of P2 fall into the piece X's portion which has not been downloaded.

So, the player calculates one estimated value of the play period that the piece X actually occupies according to the bit rate of the media file.

As compression algorithms will adjust the bit rate dynamically according to real situation of the media file, that is, both the time period corresponding to each data piece or the number of frames included in the each data piece are not certain, and the description information about these frames may be included in the index information.

For example, it is assumed that the piece size of the media file is 256 Kbyte and the average bit rate is 512 kbps, then each data piece occupies 4 seconds approximately. The computing manner of the average bit rate is: average bit rate=overall size of data portion/the media file's play period given by the file control information.

It is assumed that P2 is at 5 minute 10 second, and therefore, the piece X which has not been downloaded is skipped over so as to go to for example 5 minute 14 second, and the index information is read and then the frame corresponding to 5 minute 14 second is queried. After the offset location of the frame in the file is acquired, it is queried whether the file piece corresponding to the offset location is the piece X. If so, the download of the frame must have not been finished, and then the next frame will be searched till one frame is located in the piece X+1 completely (both the offset location corresponding to the beginning time point and the offset location corresponding to the ending time point fall into the piece X+1), and the frame is Pm+1. After acquired, the Pm+1 is given to the decoder to be decoded.
Another case is that, the frame corresponding to 5 minute 14 second is at the Pm+3, and the former frames go to waste slightly. Preferably, several frames which have been downloaded can be searched backwards (along the direction towards the header of data portion) and then given to the decoder to be decoded, thereby reducing the lost of downloaded frames.

### A Sixteenth Embodiment

### An Apparatus for Controlling on-Demand Play of Non-Streaming Media Files According to the Fourth Aspect of the Present Invention, in which Download Priorities of Data Pieces are Determined According to the Current Play Location, and Both a Frame Skip Pattern and a Drag and Drop Function are Supported

When watching a media file, a user may need to choose one play location as a new current play location, and this is the drag and drop function that we call. At present, the implementing manner of drag and drop mainly includes: a. the user may drag the seek bar on the player to the designated location (one time point) with a mouse; b. the user may input one time point directly to let the file play sequentially from the time point.

In this embodiment, the fourth determining means 206 needs to determine the new current play location according to the user denoting information. Consequently, the third determining means 2040 determines data pieces whose download should be given high priority according to the new current play location which is determined according to the user denoting information; and the second judging means 2050 judges whether the download of the frame corresponding to said new current play location has been finished.

After the user sends to a second on-demand play control means the user denoting information with computer peripherals, the determination of the new current play location can be implemented according to the following operations:
receiving the user denoting information; and
searching one play location corresponding to the time point according to the time point in the user denoting information and based on the index information, specifically, searching one intra frame corresponding to the time point;
if the time point just corresponds to one intra frame, the decoding and the like operations are implemented on the frame group where the intra frame is located;
if the time point does not correspond to a intra frame, one intra frame closet to the time point is searched preferably, and more preferably, one intra frame closet to the time point and after the time point in terms of play sequence is searched.

Next, the determined frame group where the intra frame is located is decoded, specifically, the second judging means 2050 implements the judging steps on the frame group, the detailed description thereof can be referred to the above each embodiment.

The fourth embodiment has one variation, the brief description of which is given as follows:
reading the index information, searching the frame closet to the time in the user denoting information, and acquiring the beginning and ending locations of the frame in the media file;
searching the data piece corresponding to said beginning and ending locations;
judging whether the download of the piece has been finished;
   if the download has not been finished, waiting until the download of the piece is finished (or implementing the frame skip automatically according to the third embodiment); and then, the data piece is determined as the one (with the highest priority) whose download should be given high priority;
   if the download has been finished, reading the frame and giving it to the decoder to be decoded, and the first data piece of which the download has not been finished is determined as the data piece whose download should be given high priority.

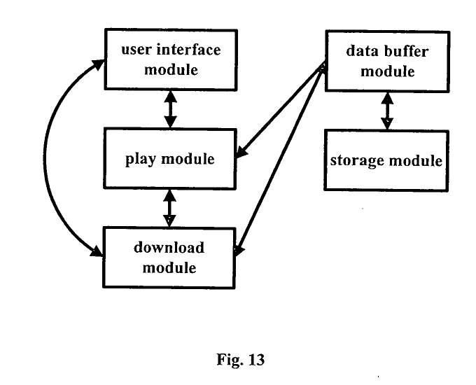

FIG. 13 is a schematic diagram illustrating the P2P software architecture of the on-demand play scheme proposed by the present invention, in which a user interface module, a play module, a download module, a data buffer module and a storage module are included.

The user interface module is for use in controlling the play module and the download module according to a user's instructions, for example, starts/stops the play, drags the play and starts/stops the download.

A real test situation of the present invention is briefly given as follows. The test is based on the following assumptions without loss of generality:
the media file is a RMVB file with a size of 500 MB, the control information thereof is about 50 KB and the index information is around 100 KB;
the playing time is 120 minutes approximately;
the bit rate=500 MB/(120*60)=69 KBPS;
the node attempting to play the media file while downloading in this test is an ADSL user whose bandwidth is IM, and the download speed is generally 100 KBPS-120 KBPS;
there are other 5 nodes on the network for providing the file pieces which can be downloaded by the test node, and the download speed of said 5 nodes is the same as that of the test node, i.e., 20 KBPS;
the size of a P2P file piece is usually 128 KB-256 KB, and therefore, the complete download of one file piece by a user will cost 6-7 seconds.

At first, the test node starts a corresponding on-demand task according to the user's instruction (for example, the user moves the cursor to one link or button corresponding to the on-demand play instruction of the media file on the webpage and presses the left button);

and then, there will be a startup period of about 10 seconds, during which the test node acquires the Torrent file and connects to other nodes;

in this process, the download of only two pieces located at the header and tail of the media file can ensure that all control information pieces and index information pieces can be downloaded, since the sizes of both file control information and index information in this test are below the piece size.

Therefore, it is arranged that the control information piece is downloaded from one of said 5 nodes, the index information piece from another one of said 5 nodes, and 3 data pieces following the control information piece closely from the rest 3 nodes; and
based on this, the play of the media file can be started (the download is implemented at the same time) after 6-7 seconds.

Although the embodiments of the present intention have been described, the present invention is not limited to the specific system, apparatus and specific protocols, and those skilled in the art may make various variations and modifications within the scope claimed by the appended claims.

1. A method for controlling on-demand play of streaming media file based on P2P protocols in a user apparatus, comprising the following steps of:
a. determining all control information pieces including file control information among plurality of pieces of said media file; and
b. acquiring said file control information based on the determined all control information pieces.

2. The method according to claim 1, further comprising the steps of:
acquiring resource related information of plurality of other user apparatus;
said step b comprises:
b1. downloading the determined all control information pieces according to the resource related information of said other plurality of user apparatus; and
b2. extracting said file control information from the all control information pieces.

3. The method according to claim 1, further comprising the steps of:
c. downloading one or more data pieces of said media file; and
d. processing the downloaded data according to said file control information, to generate processed data for playing.

4. The method of claim 3, wherein said step c comprises:
c1. determining a data piece with the highest download priority, according to a current play location;
c2. judging, according to the resource related information of the plurality of other user apparatus, whether said data piece with the highest download priority is included in the downloadable pieces of said plurality of other user apparatus; and
c3. downloading said data piece with the highest download priority, if said data piece with the highest download priority is included in the downloadable pieces of said plurality of other user apparatus.

5. The method of claim 4, wherein said step c comprises:
c3′. treating a next data piece next to the data piece with the highest download priority among plurality of data pieces of the media file as a new data piece with the highest download priority and then repeating the step c2, in the case that said data piece with the highest download priority is not included in the downloadable pieces of said plurality of other user apparatus.

6. The method of claim 4, wherein said step d comprises:
d1. judging whether the frame corresponding to the current play location is included in the downloaded data pieces; and
d2. processing said frame corresponding to the current play location to generate processed data for playing, if the frame corresponding to the current play location is included in the downloaded data piece.

7. The method according to claim 6, further comprising the steps of:
obtaining index information of said media file.

8. The method of claim 7, wherein said step of obtaining the index information of said media file comprises:
determining all index information pieces including the index information among plurality of pieces of said media file;
downloading all said determined index information pieces; and
extracting said index information from said all index information pieces.

9. The method of claim 7, wherein said step d further comprises:
d2′. judging, based on said index information, whether a frame corresponding to another play location is included in the downloaded data pieces, in the case that said frame corresponding to said current play location is not included in the downloaded data pieces; and
d3′. treating the other play location as a new current play location and implementing the step d2, if the frame corresponding to the other play location is included in the downloaded data piece.

10. The method of claim 9, wherein said step d2′ comprises:
judging, based on said index information, whether a frame corresponding to a next play location next to said current play location is included in the downloaded data pieces, in the case that the frame corresponding to said current play location is not included in the downloaded data pieces; and
said step d3′ further comprises: treating the next play location as the new current play location and implementing the step d2, if the frame corresponding to the next play location next to said current play location is included in the downloaded data pieces.

11. The method of claim 7, further comprising the step of:
determining a new current play location according to user denoting information and said index information;
said step c1 further comprises: determining the data piece with the highest download priority according to said new current play location;
said step d1 further comprises: judging whether said frame corresponding to the new current play location is included in the downloaded data pieces; and
said step d2 further comprises: processing said frame corresponding to said new current play location to generate processed data for playing, in the case that the frame corresponding to said new current play location is included in the downloaded data pieces.

12. The method of claim 6, wherein said corresponding frame comprises an intra frame.

13. The method of claim 12, wherein said corresponding frame comprises an intra frame and one or more predictive frame corresponding to said intra frame.

14. The method of claim 1, wherein said streaming media file comprises a RM format file, a RMVB format file, a WMV format file and an ASF format file.

15. A method for controlling on-demand play of non-streaming media files based on P2P protocols in a user apparatus, comprising the following steps of:
o. determining all control information pieces including file control information among plurality of pieces of said media file;
p. obtaining said file control information based on all said determined control information pieces; and
q. acquiring the index information of the media file.

16. The method according to claim 15, further comprising the step of:
acquiring resource related information of plurality of other user apparatus;
said step p comprises:
p1. downloading the determined all control information pieces based on said resource related information of the plurality of other user apparatus; and
p2. extracting said file control information from the all control information pieces.

17. The method according to claim 15, wherein said step q comprises:
q1. determining the all index information pieces including the index information among plurality of pieces of said media file; and
q2. obtaining said index information based on the determined all index information pieces.

18. The method of claim 15 further comprising the steps of:
r. downloading one or more data pieces of said media file; and
s. processing the downloaded data to generate processed data for playing, based on said file control information and said index information.

19. The method of claim 18, wherein said step r comprises:
r1. determining a data piece with the highest download priority, according to the current play location;
r2. judging, based on said resource related information of the plurality of other user apparatus, whether said data piece with the highest download priority is included in the downloadable pieces of said plurality of other user apparatus; and
r3. downloading the data piece with the highest download priority, in the case that said data piece with the highest download priority is included in downloadable pieces of plurality of other user apparatus.

20. The method of claim 19, wherein said step r comprises:
r3′. treating a next data piece next to the data piece with the highest download priority in the media file as a new data piece with the highest download priority and repeating the step r2, if said data piece with the highest download priority is not included in said downloadable piece of the plurality of other use apparatus.

21. The method of claim 19, wherein said step s comprises:
s1. judging whether said frame corresponding to the current play location is included in the downloaded data pieces; and
s2. processing said frame corresponding to the current play location to generate processed data for playing, if the frame corresponding to the current play location is included in the downloaded data pieces.

22. The method of claim 21, wherein said step s further comprises:
s2′. judging, based on said index information, whether a frame corresponding to another play location is included in the downloaded data pieces, if the frame corresponding to the current play location is not included in the downloaded data pieces; and
s3′. treating the another play location as a new current play location and implementing the step s2, in the case that the frame corresponding to the another play location is included in the downloaded data pieces.

23. The method of claim 22, wherein said step s2′ further comprises:
judging, based on said index information, whether the frame corresponding to a next play location next to said current play location is included in the downloaded data pieces, if the frame corresponding to said current play location is not included in the downloaded data pieces; and
said step s3′ further comprises: treating the next play location as the new current play location and implementing the step s2, if the frame corresponding to the next play location of said current play location is included in the downloaded data pieces.

24. The method of claim 21, further comprising the steps of:
determining a new current play location according to user denoting information;
said step r1 further comprises: determining the data piece with the highest download priority according to said new current play location;
said step s1 further comprises: judging whether said frame corresponding to the new play location is included in the downloaded data pieces; and
said step s2 further comprises: processing said frame corresponding to said new current play location to generate processed data for playing, in the case that the frame corresponding to said new current play location is included in the downloaded data pieces.

25. The method of claim 21, wherein said corresponding frame comprises an intra frame.

26. The method of claim 25, wherein said corresponding frame comprises a intra frame and one or more predictive frame corresponding to said intra frame.

27. The method of claim 15, wherein said non-streaming media file comprises an AVI format file.

28. A first on-demand play control means for controlling on-demand play of streaming media files based on P2P protocols in a user apparatus, comprising:
a first determining means for determining all control information pieces including file control information among plurality of pieces of said media file; and
a first obtaining means for obtaining said file control information based on all said determined control information pieces.

29. The first on-demand play control means of claim 28, further comprising:
an acquiring means for acquiring resource related information of plurality of other user apparatus;
said first obtaining means further comprising:
a first downloading means for downloading the determined all control information pieces according to the resource related information of the plurality of other user apparatus; and
a first extracting means for extracting said file control information from said all control information pieces.

30. The first on-demand play control means of claim 28, further comprising:
a second downloading means for downloading one or more data pieces of said media file; and
a data processing means for processing, based on said file control information, the downloaded data to generate processed data for playing.

31. The first on-demand play control means of claim 30, wherein said second downloading means comprises:
a second determining means for determining a data piece with the highest download priority according to the current play location;
a first judging means for judging, based on said resource related information of the plurality of other user apparatus, whether said data piece with the highest download priority is included in downloadable pieces of said plurality of other user apparatus; and
a controlled downloading means for downloading the data piece with the highest download priority, when said data piece with the highest download priority is included in the downloadable pieces of plurality of other user apparatus.

32. The first on-demand play control means of claim 31, wherein said first judging means is further used for treating a next data piece next to the data piece with the highest download priority among plurality of data pieces of the media file as a new data piece with the highest download priority and then judging, based on said resource related information of the plurality of other user apparatus, whether said new data piece with the highest download priority is included in downloadable pieces of plurality of other user apparatus, when said data piece with the highest download priority is not included in the downloadable pieces of said plurality of other user apparatus.

33. The first on-demand play control means of claim 31, wherein said data processing means comprises:
a second judging means for judging whether a frame corresponding to a current play location is included in the downloaded data pieces; and
a controlled processing means for processing said frame corresponding to the current play location to generate processed data for playing, when the frame corresponding to the current play location is included in the downloaded data pieces.

34. The first on-demand play control means of claim 33, further comprising:
a second obtaining means for obtaining the index information of said media file.

35. The first on-demand play control means of claim 34, wherein said second obtaining means comprises:
a third determining means for determining the all index information pieces including the index information among said plurality of pieces of media file;
a third downloading means for downloading all said determined index information pieces; and
a second extracting means for extracting said index information from said all index information.

36. The first on-demand play control means of claim 34, wherein
said second judging means is further for judging, based on said index information, whether the frame corresponding to another play location is included in the downloaded data pieces, when the frame corresponding to the current play location is not included in the downloaded data pieces; and
said controlled processing means is further for treating the another play location as the new current play location and processing the frame corresponding to the new play location to generate processed data for playing, when the frame corresponding to the another play location is included in the downloaded data pieces.

37. The first on-demand play control means of claim 36, wherein:
said second judging means is further for judging, based on said index information, whether the frame corresponding to the next play location next to said current play location is included in the downloaded data pieces, when the frame corresponding to said current play location is not included in the downloaded data pieces; and
said controlled processing means is further for treating the next play location as the new current play location and processing said frame corresponding to the new current play location to generate processed data for playing, if the frame corresponding to the next play location next to said current play location is included in the downloaded data pieces.

38. The first on-demand play control means of claim 34, further comprising:
a fourth determining means for determining a new current play location according to user denoting information and said index information;
said first determining means is further used for determining the data piece with the highest download priority according to said new current play location;
said second judging means is further for judging whether said frame corresponding to the new play location is included in the downloaded data pieces; and
said controlled processing means is further used for processing said frame corresponding to the new current play location to generate processed data for playing, if the frame corresponding to the new current play location is included in the downloaded data pieces.

39. The first on-demand play control means of claim 33, wherein said corresponding frame comprises an intra frame.

40. The first on-demand play control means of claim 39, wherein said corresponding frame comprises an intra frame and one or more predictive frame corresponding to said intra frame.

41. The first on-demand play control means of claim 28, wherein said streaming media file comprises a RM format file, a RMVB format file, a WMV format file and an ASF format file.

42. A second on-demand play control means for controlling on-demand play of non-streaming media files based on P2P protocols in a user apparatus, comprising:
a first determining means for determining all control information pieces including file control information in plurality of pieces of said media file; and
a first obtaining means for obtaining said file control information based on all said determined control information pieces; and
a second obtaining means for obtaining index information of the media file.

43. The second on-demand play apparatus of claim 42, further comprising:
an acquiring means for acquiring resource related information of plurality of other user apparatus;
said first obtaining means further comprises:
a first downloading means for downloading the determined all control information pieces according to the resource related information of the plurality of other user apparatus; and
a first extracting means for extracting said file control information from said all control information pieces.

44. The second on-demand play apparatus of claim 42, wherein said second obtaining means further comprises:
a second determining means for determining all index information pieces including the index information among said plurality of pieces of media file;
a second downloading means for downloading all said determined index information pieces; and
a second extracting means for extracting said index information from said all index information.

45. The second on-demand play control means of claim 42, further comprising:
a third downloading means for downloading one or more data pieces of said media file; and
a data processing means for processing, based on said file control information and said index information, the downloaded data to generate processed data for playing.

46. The second on-demand play control means of claim 45, wherein said third downloading means comprises:
a third determining means for determining a data piece with the highest download priority according to the current play location;
a first judgment for judging, based on said resource related information of the plurality of other user apparatus, whether said data piece with the highest download priority is included in downloadable pieces of said plurality of other user apparatus; and
a controlled downloading means for downloading the data piece with the highest download priority, when said data piece with the highest download priority is included in downloadable pieces of plurality of other user apparatus.

47. The first on-demand play control means of claim 46, wherein said first judging means is further used for treating a next data piece next to the data piece with the highest download priority among plurality of data pieces of the media file as a new data piece with the highest download priority and then judging, based on said resource related information of the plurality of other user apparatus, whether said new data piece with the highest download priority is included in downloadable pieces of plurality of other user apparatus, when said data piece with the highest download priority is not included in the downloadable pieces of said plurality of other user apparatus.

48. The second on-demand play apparatus of claim 46, wherein said data processing means comprises:
a second judging means for judging whether said frame corresponding to the current play location is included in the downloaded data pieces; and
a controlled processing means for processing said frame corresponding to the current play location to generate processed data for playing, when the frame corresponding to the current play location is included in the downloaded data pieces.

49. The second on-demand play apparatus of claim 48, wherein
said second judging means is further for judging, based on said index information, whether the frame corresponding to another play location is included in the downloaded data pieces, when the frame corresponding to the current play location is not included in the downloaded data pieces; and
said controlled processing means is further for treating the another play location as the new current play location and processing the frame corresponding to the new play location to generate processed data for playing, when the frame corresponding to the another play location is included in the downloaded data pieces.

50. The second on-demand play apparatus of claim 49, wherein
said second judging means is further for judging, based on said index information, whether the frame corresponding to the next play location next to said current play location is included in the downloaded data pieces, when the frame corresponding to said current play location is not included in the downloaded data pieces; and
said controlled processing means is further used for treating the next play location as the new current play location and processing said frame corresponding to the new current play location to generate processed data for playing, if the frame corresponding to the next play location of said current play location is included in the downloaded data pieces.

51. The second on-demand play apparatus of claim 48, further comprising:
a fourth determining means for determining a new current play location according to user denoting information;
said third determining means is further for determining the data piece with the highest download priority according to said new current play location;
said second judging means is further used for judging whether said frame corresponding to the new play location is included in the downloaded data pieces; and
said controlled processing means is for used in processing said frame corresponding to said new current play location to generate processed data for playing, when the frame corresponding to said new current play location is included in the downloaded data pieces.

52. The second on-demand play control means of claim 48, wherein said corresponding frame comprises an intra frame.

53. The on-demand play control means of claim 52, wherein said corresponding frame comprises an intra frame and one or more predictive frame corresponding to said intra frame.

54. The second on-demand play control means of claim 42, wherein said non-streaming media file comprises an AVI format file.

55. An on-demand play control apparatus for controlling play of media files in a user apparatus, comprising said first on-demand play control means of claim 28.

56. An on-demand play control apparatus for controlling play of media files in a user apparatus, comprising said first on-demand play control means of claim 28, and a second obtaining means for obtaining index information of the media file.

57. An on-demand play control apparatus for controlling play of media files in a user apparatus, comprising said second on-demand play control means of claim 42.
